(19) United States
(12) Patent Application Publication
(10) Pub. No.: US 2004/0211329 A1
(43) Pub. Date: Oct. 28, 2004

(54) Pattern forming method and pattern forming device

(76) Inventors: Katsuyuki Funahata, Hitachi-shi (JP); Tetsurou Minemura, Kumagaya-shi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/487,074

(22) PCT Filed: Sep. 4, 2002
(86) PCT No.: PCT/JP02/09005

(30) Foreign Application Priority Data
Sep. 18, 2001 (JP) 2001-282571

(51) Int. Cl. B41N 3/00

(52) U.S. Cl. 101/463.1

(57) ABSTRACT

The invention provides a pattern forming method and a pattern forming apparatus which can form a micro pattern at a low cost. The pattern forming apparatus has a member in which a printing pattern is formed on a surface and at least the surface having the printing pattern formed thereon is siliconized, a resin supplying means for supplying a resin to one face of the surface having the pattern formed thereon in the member, and a supporting means for supporting a subject to be printed so as to transcribe the resin supplied to the member on the subject to be printed. The siliconization is achieved by arranging a silicone rubber, a silicone resin or a silicone sheet on the surface of the member. The member is formed, for example, in a cylindrical shape.

### TECHNICAL FIELD

The present invention relates to a printing method and a printing apparatus, and more particularly to a pattern forming method and a pattern forming apparatus for forming a micro pattern by a minimum man-hour.

### BACKGROUND ART

In conventional, as a basic structure of a planographic or letterpress offset printing machine, there has been proposed a printing apparatus constituted by a blanket cylinder, an intaglio printing plate or a relief printing plate, and an ink supplying means. Further, there has been proposed a pattern forming method using the same.

Further, as shown in JP-A-11-58921, there has been proposed a method of forming a pattern by removing an unnecessary portion from an ink film formed in the blanket cylinder having an ink repellent by using the relief printing plate, and an apparatus used for the method.

All of the prior arts relate to the method of forming an ink pattern on the blanket cylinder via the relief or intaglio printing plate, and it is necessary to transcribe the ink at a great number of times until the ink pattern is printed on a subject to be printed. Accordingly, it is hard to maintain a pattern shape or a surface shape until the ink pattern is printed on the subject to be printed. On that account, it is very hard to form, for example, a micro shape and a linear pattern of a micro line width and pitch in which circular convex portions or concave portions are arranged in a closest packing manner.

Further, since a lot of man-hour is required as well as the structure of the apparatus is complex, a cost increase is generated.

Further, there is a problem that the prior art can not form a pattern in which a distribution of angles of inclination is asymmetrical in the circular convex portion or concave portion employed in a diffused reflecting plate.

### DISCLOSURE OF THE INVENTION

An object of the present invention is to provide a pattern forming method capable of forming a micro pattern, and a manufacturing apparatus of the same.

Another object of the present invention is to provide a pattern forming method capable of controlling a shape of the micro pattern as well as forming the micro pattern, and a manufacturing apparatus of the same.

In accordance with one aspect of the present invention, there is provided a method of forming a pattern comprising the steps of:

forming (arranging) a resin on one face on a member in which a printing pattern is formed on a surface and at least the surface having the printing pattern formed thereon is siliconized; and

transcribing the resin formed on the member on a subject to be printed.

Further, the siliconization is achieved by coating a silicone on the surface of the member, or arranging a silicone rubber, a silicone resin or a silicone sheet on the surface of the member.

Further, the resin is formed on the member in such a manner that a thickness of the resin is approximately uniform.

In accordance with another aspect of the present invention, there is provided a pattern forming apparatus comprising:

a member in which a printing pattern is formed on a surface and at least the surface having the printing pattern formed thereon is siliconized;

a resin supplying means for supplying a resin to one face of the surface having the printing pattern formed thereon in the member; and

a supporting means for supporting a subject to be printed so as to transcribe the resin supplied to the member on the subject to be printed.

Further, the siliconization is achieved by coating a silicone on the surface of the member, or arranging a silicone rubber, a silicone resin or a silicone sheet on the surface of the member.

Further, the member may be formed in a cylindrical shape or in a flat plate shape.

Further, the resin supplying means supplies the resin to one face of the surface of the member in such a manner that the thickness becomes approximately uniform.

Further, the resin supplying means supplies the resin to the member from a resin supplying port. A siliconization is applied to the resin supplying port.

As the resin supplying means, there can be considered a die coater, a wire bar coater, a blade coater, a kiss coater or the like.

In accordance with the other aspect of the present invention, there is provided a pattern forming apparatus comprising:

a blanket cylinder having a printing plate function and a ink separating function;

a means for forming and supplying an ink solid to the blanket cylinder; and

a supporting means for supporting a subject to be printed.

Further, the blanket cylinder is provided with a silicone, a silicone rubber, a silicone resin or a silicone sheet on a surface thereof.

Further, the silicone rubber, the silicone resin or the silicone sheet attached to the surface of the blanket cylinder has a printing pattern.

The pattern forming method and the pattern forming apparatus in accordance with the present invention is effective for all of pattern formations such as a micro pattern formation, for example, a light-emitting layer for an organic electroluminescent display, an organic semiconductor for a thin film transistor, and the like, a pattern requiring a cross sectional shape control, for example, a concavity and convexity pattern of a diffused reflecting plate employed for a high reflective liquid crystal display apparatus, and the like as well as a photosensitive polymer pattern printing and a colored ink pattern printing.

Further, in the case that the concavity and convexity resin layer for the diffused reflecting plate is formed in accordance with the pattern forming method of the present invention, all of the resin coated film formed on the blanket surface is transcribed onto the subject to be printed (hereinafter, refer to as a whole area transcribing method), so that any unnecessary resin does not remain. Accordingly, a mechanism for removing the remaining resin is not required, and there is an effect that the apparatus can be made compact and inexpensive.

On the other hand, in the case of printing the photosensitive resin for patterning a transparent electrode in accordance with the pattern forming method of the present invention, only the photosensitive resin on a convex portion of the concavity and convexity pattern formed on the blanket is transcribed onto the subject to be printed, that is, a so-called partial transcription (hereinafter, refer to as a partial transcribing method) is executed, so that in order to achieve an accurate pattern formation, it is more preferable to make a depth of the concave portion lager than a thickness of the photosensitive resin layer formed on the convex portion.

Further, in the partial transcribing pattern forming method in accordance with the present invention, the resin applying surface is formed on a polymer film to which the siliconization is applied, without directly forming the resin applying surface on the blanket, and the resin applying surface is formed only on the convex portion of the silicone rubber blanket provided with the concavity and convexity pattern and is transcribed onto the subject to be printed. Accordingly, since any unnecessary residual resin layer is not generated in the same manner as the formation of the diffused reflecting plate mentioned above, there is an effect that the apparatus can be made compact and inexpensive.

Further, in a printing apparatus having a blanket cylinder and executing a pattern printing by temporarily transferring a patterned resin or ink to the blanket, the blanket is provided with a printing plate function and a ink separating function for making a resin or an ink to be easily peeled.

Further, in accordance with the whole area transcribing method of the present invention, since the application face for the resin or the ink is directly formed on the blanket, it is possible to obtain an effect that the number of steps can be reduced and the apparatus can be simplified.

Further, in accordance with the partial transcribing method of the present invention, the resin or ink coated film is formed on the member having the ink separating function, without directly forming the resin or the ink on the blanket, and the resin or ink coated film is transferred onto the convex pattern portion formed on the blanket surface from the coated surface, and is transcribed onto the subject to be printed. Accordingly, the unnecessary resin or ink does not remain on the blanket, and a pattern repeatability is high.

### BRIEF DESCRIPTION OF THE DRAWINGS

FIG. 1 is a schematic cross sectional view of an embodiment 1 showing a structure of an apparatus for directly forming a resin or an ink onto a blanket surface provided with a printing plate function and a ink separating function in accordance with the present invention;

FIG. 2 is a schematic cross sectional view of an embodiment 2 showing a structure of an apparatus for directly forming a resin or an ink onto a blanket surface provided with a printing plate function and a ink separating function in accordance with the present invention;

FIG. 3 is a schematic cross sectional view of an embodiment 3 showing a structure of an apparatus for directly forming a resin or an ink onto a blanket surface provided with a printing plate function and a ink separating function in accordance with the present invention;

FIG. 4 is a schematic cross sectional view of an embodiment 4 showing a structure of an apparatus for indirectly forming a resin or an ink onto a blanket surface provided with a printing plate function and a ink separating function in accordance with the present invention;

FIG. 5 is a schematic cross sectional view of an embodiment 5 showing a structure of an apparatus for indirectly forming a resin or an ink onto a blanket surface provided with a printing plate function and a ink separating function in accordance with the present invention;

FIG. 6 is a schematic cross sectional view of an embodiment 6 showing a structure of an apparatus for indirectly forming a resin or an ink onto a blanket surface provided with a printing plate function and a ink separating function in accordance with the present invention;

FIG. 7 is a schematic cross sectional view of an embodiment 7 showing a structure of a continuous film corresponding apparatus for directly forming a resin or an ink onto a blanket surface provided with a printing plate function and a ink separating function in accordance with the present invention;

FIG. 8 is a view showing an embodiment of a concavity and convexity pattern formed on a blanket for a reflecting diffuser for displaying a reflection or displaying both a reflection and a transmission which is used in a pattern forming method in accordance with the present invention;

FIG. 9 is a view showing an embodiment of a method of forming a blanket for a reflecting diffuser for displaying a reflection or displaying both a reflection and a transmission which is used in a pattern forming method in accordance with the present invention;

FIG. 10 is a view showing another embodiment of a concavity and convexity pattern formed on the blanket for the reflecting diffuser for displaying both the reflection and the transmission which is used in a pattern forming method in accordance with the present invention;

FIG. 11 is a view showing an embodiment of a blanket forming method of the reflecting diffuser for displaying both the reflection and the transmission which is used in the pattern forming method in accordance with the present invention;

FIG. 12 is a cross sectional view showing an embodiment of a transparent electrode forming method using the pattern forming method in accordance with the present invention;

FIG. 13 is a cross sectional view showing an embodiment of an electrode substrate for a reflective liquid crystal display apparatus using the pattern forming method in accordance with the present invention;

FIG. 14 is a cross sectional view showing an embodiment of a reflective liquid crystal display element using the pattern forming method in accordance with the present invention;

FIG. 15 is a cross sectional view showing an embodiment of the reflective liquid crystal display apparatus using the pattern forming method in accordance with the present invention;

FIG. 16 is a view showing an embodiment of an optical system estimating an optical performance of the reflective liquid crystal display apparatus using the pattern forming method in accordance with the present invention;

FIG. 17 is a view showing an embodiment of the optical performance of the reflective liquid crystal display apparatus using the pattern forming method in accordance with the present invention;

FIG. 18 is a cross sectional view showing an embodiment of a method of forming a light guide for a front light using the pattern forming method in accordance with the present invention; and

FIG. 19 is a cross sectional view showing an embodiment of a printed circuit board forming method using the pattern forming method in accordance with the present invention.

### BEST MODE FOR CARRYING OUT THE INVENTION

One of the features of the present invention is to apply both of a printing plate function and a ink separating function to a member (for example, a flat plate, a cylindrical member or the like) used at a time of printing a material (for example, a resin) corresponding to a print subject on a subject to be printed.

The printing plate function is constituted by supplying the resin corresponding to the print subject onto a member having a predetermined pattern formed thereon so as to have a uniform thickness all around the surface, and printing (or transcribing) the resin to which a pattern is applied by the member having the pattern formed thereon, on the subject to be printed, for example, a glass substrate, thereby forming the pattern on the subject to be printed. In this case, this pattern can be freely determined at a time of intending to print, and it is of course possible to set a strap-shaped random concavity and convexity pattern (concavity and convexity pitch: 3 to 12 μm, concavity and convexity depth: 0.1 to 0.8 μm) constituted by a phase separation pattern, for example, generated in a copolymer or the like to the predetermined pattern. As a specific pattern example, there can be listed up a concavity and convexity resin pattern of a built-in reflecting diffuser used in a reflective liquid crystal display apparatus. This pattern is most preferable for a method of forming a resin pattern provided with a small random corrugated surface arranged such that a strap-shaped continuous concavity and convexity is approximately symmetrical in a slope angle distribution of a cross sectional shape in a perpendicular direction to a longitudinal direction and a sum of length components in the perpendicular direction of the strap-shaped concavity and convexity to the longitudinal direction is approximately uniform in each of the directions, such as the phase separation pattern generated in the copolymer or the like, and there are also features, that is, not only the structure of the apparatus is simple, but also the pattern can be formed only by transcribing to the subject to be printed, so that a shape reproducibility is high.

In addition to the micro linear pattern, it is of course possible to employ a shape (a pattern) provided with a micro random corrugated surface in which a cross sectional shape is controlled in a semicircular shape, a semi-cylindrical shape, a triangular shape or the like.

Further, the ink separating function is constituted by well printing the resin pattern on the subject to be printed by making the resin to be easily peeled at a time of printing the resin having the pattern formed thereon on the subject to be printed. As a specific means for making the resin to be easily peeled, a silicone is arranged on the front surface of the member used at a time of printing the material corresponding to the printing subject to the subject to be printed. As the arrangement in this case, there can be considered silicone coating the front surface or attaching a silicone rubber sheet or a silicone resin sheet to the front surface. Of course, a flat or cylindrical member is prepared, and the silicones, for example, having the concavity and convexity pattern formed thereon are combined so as to be employed as a member used at a time of printing the material corresponding to the printing subject on the subject to be printed.

Since the pattern on the blanket can be transcribed to the resin or the ink at the same time of forming the coated surface of the resin or the ink, by applying the printing plate function and the ink separating function to the member used at a time of printing the material corresponding to the printing subject to the subject to be printed, it is possible to print by the minimum number of steps constituted only by a step of transcribing the coated surface such as the resin or the ink on the member used at a time of printing the material corresponding to the printing subject to the subject to be printed, and a stringiness phenomenon is not generated at a time when the resin or the ink is apart from the member used at a time of printing the material corresponding to the printing subject to the subject to be printed. Accordingly, the surface of the concavity and convexity pattern transcribed on the subject to be printed becomes smooth, and a good micro pattern can be formed. For example, in the case of forming the concavity and convexity shape of the reflection plate in accordance with the pattern forming method, not only it is possible to form a concavity and convexity resin layer for the reflecting diffuser indicating an excellent reflection property, but also it is possible to provide a high-performance built-in reflecting diffuser having a concavity and convexity of a micro scale and a small depth.

A description will be given of the pattern forming method in accordance with the present invention by exemplifying a case of forming the concavity and convexity shape corresponding to the pattern of the reflecting diffuser built in the reflective liquid crystal display apparatus by using the resin as the material corresponding to the printing subject. The specific pattern forming method is as follows.

In other words, the resin corresponding to the printing subject material with respect to the subject to be printed is formed all the front surface of the member (for example, a cylindrical blanket) provided with the printing plate function and the ink separating function corresponding to the feature of the present invention at a uniform thickness, and the pattern-formed resin is printed (in other words, transcribed) on the subject to be printed, for example, a glass substrate or a film substrate. In this case, the printing pattern formed on the blanket surface is, for example, a strap-shaped random concavity and convexity pattern, in which a concavity and convexity pitch is between 3 and 12 μm and a concavity and convexity depth is between 0.1 and 0.8 μm.

Further, it is also important to make the resin supplied from the resin supplying means to be easily peeled from the resin supplying means, at a time of supplying the resin to the member used at a time of printing the material corresponding to the printing subject to the subject to be printed.

Specifically, the separation of the resin from a head is improved by applying a silicone rubber, a silicone resin or a silicone coating treatment to a head portion corresponding to the resin supplying port of the resin supplying means. As the resin supplying means, a die coater, a wire bar coater, a kiss coater or the like can be considered. In the case of the die coater, the structure is made such that the silicone, the silicone rubber or the silicone resin coating treatment is applied to the head portion corresponding to the resin supplying port. In the case of the wire bar coater, the structure is made such that the silicone rubber, the silicone resin coating or the silicone coating treatment is applied to the wire bar surface, thereby improving the separation of the resin from the wire bar. In the case of the kiss coater, the structure is made such that the resin coated film is formed in a belt-shaped silicone coat via a rotogravure roll having a surface to which the silicone rubber, the silicone resin coating or the silicone coating treatment is applied to.

Since the ink separating function is provided in the member used at a time of printing the material corresponding to the printing subject with respect to the subject to be printed or the ink separating function is provided in the resin supplying unit, it is possible to transcribe on the subject to be printed without generating the stringiness phenomenon in the material such as the resin or the ink. Accordingly, not only it is possible to form a color filter which is excellent in a surface smoothness, but also it is possible to form a pattern requiring a shape control such as a concavity and convexity resin layer for a reflecting diffuser formed in accordance with a photo lithography method.

Since the resin or ink coated film is formed on the front surface of the blanket without generating any stringiness phenomenon, by applying the ink separating function to the die coater head, the wire bar, the blade and the continuously running substrate corresponding to the supply port for the resin in the resin supplying unit, the micro pattern can be formed from a thin film to a thick film.

The built-in reflecting diffuser is completed by forming a reflective layer (a thin film made of aluminum, aluminum alloy, silver, silver alloy or the like, film thickness: 100 to 300 nm) on a desired pattern printed on the subject to be printed in accordance with a sputter method or the like.

In this case, the resin used in the present embodiment belongs to an acrylic group, a melamine epoxy group, a polyester melamine group, however, the resin is selected in correspondence to an intended use and is not limited to the present embodiment.

Further, since the pattern forming method in accordance with the present invention does not require a printability with respect to the material to be used, all the materials can be used.

Further, in accordance with the reason mentioned above, the present invention can be applied to a photosensitive resin used in the photo lithography method, and has a feature used as a substitute for the photo lithography method which is a mainstream of the method of forming the micro pattern at the present.

In accordance with the pattern forming method employing the member used at a time of printing the material corresponding to the printing subject with respect to the subject to be printed provided with the printing plate function of the present invention, since it is possible to simultaneously form the pattern on the resin or the ink in a step of forming the resin or ink coated film on the pattern of the member, the method requires only the step of printing the pattern-formed resin or ink on the subject to be printed (the transcribing number of the resin or the ink is only one), and the member used at a time of printing the material corresponding to the printing subject with respect to the subject to be printed is provided with the ink separating function for making the resin or the ink to be easily peeled, the good shape reproducibility is achieved even in the micro pattern, and it is possible to obtain a pattern which is not inferior to the pattern formed in accordance with the photo lithography method.

Further, in accordance with the pattern forming method of the present invention, since the resin pattern can be transcribed on the subject to be printed by one step, it is possible to easily form the shape patterned in accordance with the photo lithography method at the present, at a high accuracy and with a low cost, the pattern including a transparent electrode for a liquid crystal display apparatus, a metal reflection film, a printed circuit board, a copper foil for a flexible printed circuit board (hereinafter, refer to FPC), and the like.

Further, in accordance with the present invention, since the printing plate function and the ink separating function can be applied only by winding the silicone rubber sheet, the silicone sheet, the metal sheet in which the concavity and convexity pattern of the stainless steel or the like having the silicone or the silicone resin coated on the front surface is formed, or the silicone sheet having the concavity and convexity pattern formed thereon, around the blanket, it is possible to correspond to a large item small scale pattern formation which is considered to be hard because a cost of a photo mask is increased in accordance with the photo lithography method.

Further, in accordance with the present invention, since the pattern can be simultaneously formed on the resin supplied onto the member used at a time of printing the material corresponding to the printing subject with respect to the subject to be printed, in the step of forming the resin or ink coated film on the front surface of the member used at a time of printing the material corresponding to the printing subject with respect to the subject to be printed, the pattern formation is completed only by transcribing the resin or the ink on the member used at a time of printing the material corresponding to the printing subject with respect to the subject to be printed to the subject to be printed. Accordingly, it is possible to provide an inexpensive pattern forming apparatus by the simple structure and the saved space.

Further, in accordance with the pattern forming method of the present invention, since no printability is required with respect to the used resin or ink, the used material is not limited.

Further, in accordance with the present invention, since the plate separation of the resin or the ink is improved owing to the use of the member employed at a time of printing the material corresponding to the printing subject with respect to the subject to be printed having the ink separating function, the resin or the ink can be printed to the resin film or the resin sheet which can not be used as the subject to be printed.

Next, a description will be given specifically of a method of forming the concavity and convexity resin layer for the reflecting diffuser and an apparatus thereof which are preferable for carrying out the present invention. In the present invention, a description will be mainly given of a method of forming a built-in reflecting diffuser for a reflection type or transflective color liquid crystal display apparatus mounted on a mobile phone or the like, and an apparatus thereof.

However, the present invention relates to a novel pattern forming method using a printing method, is variously applied, and is not limited to an intended use relating to the pattern formation relevant to the liquid crystal.

Since the pattern forming method provided with the printing plate function and the ink separating function in accordance with the present invention transcribes the pattern formed on the blanket surface to the material coated surface at the same time of forming the used resin or ink coated film on the blanket, the pattern can be formed only by transcribing the resin or ink coated film formed on the blanket surface to the subject to be printed, and can be formed by a short step, that is, the transcribing number of the resin or the ink is one. Further, since the pattern is transcribed to the subject to be printed without generating a stringiness phenomenon, an excellent shape reproducibility is obtained.

Further, in accordance with the present invention, not only it is possible to easily carry out the pattern formation in which the cross sectional shape control is required, but also it is possible to carry out the pattern formation without selecting the printed material from the glass substrate to the high polymer sheet.

Further, since the printing machine in accordance with the present invention is structured by the resin or ink coated film forming unit, the pattern forming unit constituted by the blanket provided with the plate function, and the printing unit, it is possible to provide an inexpensive pattern forming apparatus in which the apparatus is compact in size and the same quality as that of the photo lithography method can be obtained.

(Embodiment 1)

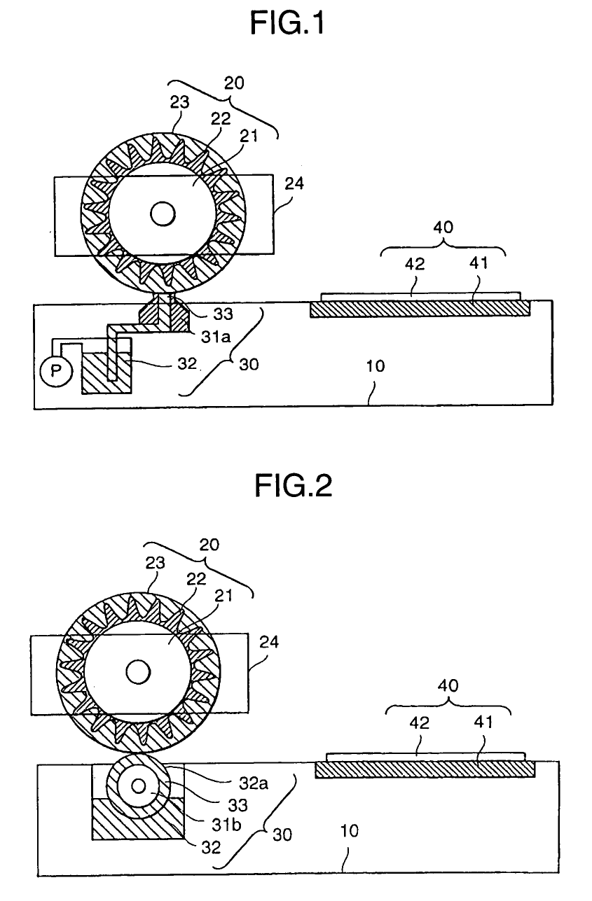

FIG. 1 shows an embodiment of a concavity and convexity resin layer forming apparatus for a reflecting diffuser using the pattern forming method in accordance with the present invention. As shown in the drawing, the pattern forming apparatus in accordance with the present invention is mainly structured by a fixed frame 10, a resin pattern forming unit 20 constituted by a cylinder 21 to which a silicone rubber blanket 22 having a lot of random and micro concavity and convexity patterns is attached, a resin supplying unit 30 constituted by a die coater having a head 31a in which a front surface is coated by a silicone resin 33 or a silicone rubber 33, and a resin reserving means 32, and a printing unit 40 constituted by a printing platen 41 and a glass substrate 42 corresponding to the subject to be printed.

A description will be in detail given of the structure of the apparatus in accordance with the present invention. The structure is made such as to mount the resin supplying unit 30 and the printing unit 40 to the fixed frame 10, and arrange a movable frame 24 on which the resin pattern forming unit 20 provided with the cylinder 21 having a rotating and vertically moving mechanism provided with a silicone rubber blanket 22 forming random micro concavity and convexity, on the fixed frame 10.

An operation of the present apparatus is as follows. First, 1) the apparatus stops the cylinder 21 on the resin supplying unit 30, moves the die coater head 31a at a distance between the silicone rubber blanket 22 provided with concavity and convexity on the surface of the cylinder 21 and the die coater head 31a, holds a gap corresponding to a thickness of the resin 32 formed on the surface of the silicone rubber blanket 21, gets off a predetermined thickness of resin 32 from the die coater head 31a, rotates the cylinder 21, and forms the resin 32 coated surface on the front surface of the blanket 22 having the concavity and convexity. Next, 2) the apparatus moves the cylinder 21 on the printing unit 40 constituted by the printing platen 41 and the glass substrate 42 corresponding to the subject to be printed, rolls the cylinder 21 in contact with the glass substrate 42 corresponding to the subject to be printed, and transcribes the resin 23 on which the concavity and convexity pattern on the blanket 22 is formed to the glass substrate 42. Accordingly, the concavity and convexity layer formation is completed by the minimum number of step (the resin pattern is transcribed to the subject to be printed by one step).

The resin 32 used in the present embodiment employs two kinds comprising a transparent acrylic or epoxy resin having no photosensitivity, and an opaque resin obtained by dispersing a color pigment to the transparent acrylic or epoxy resin. In the present embodiment, the concavity and convexity resin layer is formed by using not only the transparent resin corresponding to a transflective liquid crystal display provided with both a reflection portion and a transmission portion within one pixel, but also the resin obtained by dispersing the color pigment to the acrylic or epoxy resin, because of applying a function of corresponding to the structure in which the colored concavity and convexity resin layer serves as a light shielding layer, by patterning the reflective layer formed on the colored concavity and convexity resin layer. A black pigment is desirable for the pigment dispersed in this case.

Further, in the present embodiment, the silicone rubber blanket 22 having a lot of random micro concavities and convexities are employed as the blanket 22 provided with the printing plate function and the ink separating function, however, the same effect can be obtained as well in the case of employing a structure in which the silicone sheet having a lot of random concavities and convexities is attached to the cylinder 21.

Further, as the random concavity and convexity pattern, a phase separation pattern appearing in a high polymer block copolymer or the like is also employed. The phase separation concavity and convexity pattern used in the present embodiment is structured such that a pitch of the concavity and convexity (a pitch between crests or between valleys) is between 1 and 12 micron, a depth of the concavity and convexity is between 0.1 and 0.8 micron, and a concavity and convexity film thickness is between 0.5 and 3.0 micron, and more preferably, the pitch of the concavity and convexity (the pitch between the crests or between the valleys) is between 3 and 8 micron, the depth of the concavity and convexity is between 0.2 and 0.6 micron, and the concavity and convexity film thickness is between 1.0 and 2.0 micron.

In this case, the strap-shaped phase separation concavity and convexity pattern is used, however, the same result can be obtained as well in the case of attaching the silicone rubber blanket 22 or the silicone sheet provided with the pattern in which a lot of circular micro convexities and concavities are arranged at random, to the cylinder 21.

As an application of the present embodiment, in order to form the resin coated film having a higher accuracy, there is considered a structure in which the die coater head 31 is surface treated around a discharge port by the silicone resin 33, the silicone rubber 33, the silicone 33 or the like, in the resin coating unit 30 constituted by the die coater. As a result, it is possible to improve the separation of the resin 32 from the die coater head 31, and it is possible to prevent the stringiness phenomenon from being generated, whereby it is possible to confirm that the film thickness unevenness of the resin 32 can be prevented from being generated.

Further, by applying the present embodiment, it is possible to provide a color liquid crystal display apparatus serving both as reflection and transmission and having a structure capable of displaying approximately the same color in the transmission and reflection display, by forming the concavity and convexity layer by a black matrix (the light shielding layer) and a color filter (red, green and blue), and laminating a transflective layer or a partial reflective layer, the black matrix and the color filter (red, green and blue).

In the case of forming the concavity and convexity layer for the reflecting diffuser in accordance with the pattern forming method of the present invention, the concavity and convexity pattern by the resin can be formed on the glass substrate, substantially only by one step of printing the resin pattern formed on the blanket to the glass substrate corresponding to the subject to be printed, not only it is possible to form the high performance built-in reflecting diffuser in which the concavity and convexity shape is controlled at a low cost, but also it is possible to provide a bright reflection type or a transflective liquid crystal display apparatus at a low cost.

Further, in accordance with the pattern forming method of the present invention, even in the case of the polymer film subject to be printed which is hard to be printed, the pattern having a high accuracy can be formed because a printability is not required with respect to the used resin.

Further, in accordance with the pattern forming method of the present invention, since it is possible to easily manufacture a pattern forming apparatus in which the roll-shaped continuous film can be used, it is possible to expect a wide productivity improvement in comparison with the method of printing on the glass substrate in accordance with the currently mainstream sheet-feeding method.

(Embodiment 2)

FIG. 2 shows another embodiment of the concavity and convexity resin layer forming apparatus for the reflecting diffuser using the pattern forming method in accordance with the present invention. As shown in the drawing, a basic structure of the present invention is structured by the fixed frame 10, the pattern forming unit 20, the resin supplying unit 30, and the printing unit 40, and the apparatus structure and the transcribing principle are basically the same as those of the embodiment 1 mentioned above, however, this embodiment is different from the embodiment 1 in a point that the wire bar coater is used as the resin supplying unit 30.

The pattern forming apparatus in the present embodiment is structured such that the fixed frame 10 is provided with the resin supplying unit 30 formed by the wire bar coater constituted by a wire bar 31b and the resin supplying means 32, and the printing unit 40 constituted by the printing platen 41 and the glass substrate 42 corresponding to the subject to be printed, and on the fixed frame 10, there is provided with the cylinder 21 to which the blanket 22 provided with the printing plate function and the ink separating function is attached to the movable frame 24 for moving over the resin supplying unit 30 constituted by the wire bar coater and the printing unit 40.

An operation of the present apparatus is as follows. First, the present apparatus 1) stops the cylinder 21 to which the blanket 22 provided with the printing plate function and the ink separating function is attached, on the resin supplying unit 30 constituted by the wire bar coater, 2) brings the wire bar 31 into contact with the blanket 22 provided with the printing plate function and the ink separating function on the front surface of the cylinder 21 so as to rotate the wire bar 31 together with the blanket 22, thereby forming the resin coated film 23 having a predetermined thickness on the front surface of the blanket 22 provided with the printing plate function and the ink separating function, 3) moves the cylinder 21 on the printing platen 41 of the printing unit 40, rolls the cylinder 21 in contact with the glass substrate 42 corresponding to the subject to be printed, and transcribes the resin 23 forming the concavity and convexity pattern on the blanket 22 to the glass substrate 42. Accordingly, the concavity and convexity resin layer can be formed on the glass substrate 42 reflecting diffuser only by one step, that is, a step of transcribing the resin substantially having the concavity and convexity pattern formed thereon to the glass substrate 42 corresponding to the subject to be printed.

Further, as an application of the present embodiment, a structure in which the wire bar 31 of the resin supplying unit 30 constituted by the wire bar coater is surface treated by the silicone resin, the silicone rubber or the silicone or the like is considered. As a result, it is possible to improve the resin separation from the front surface of the wire bar 31, and it can be confirmed that the resin coated film having a small film thickness change can be formed on the blanket surface.

The resin used in the present embodiment employs two kinds comprising a transparent acrylic or epoxy resin having no photosensitivity, and an opaque resin obtained by dispersing a color pigment to the transparent acrylic or epoxy resin. In the present embodiment, the concavity and convexity resin layer is formed by using not only the transparent acrylic or epoxy resin corresponding to a transflective liquid crystal display provided with both a reflection portion and a transmission portion within one pixel, but also the resin obtained by dispersing the color pigment to the acrylic or epoxy resin, because of intending to correspond to the structure in which the concavity and convexity resin layer serves as a light shielding layer, by patterning the reflective layer formed on the concavity and convexity resin layer.

Further, the structure in which the silicone sheet or the silicone rubber having random concavity and convexity pattern is attached to the cylinder is employed as the blanket provided with the printing plate function and the ink separating function.

Further, as the random concavity and convexity pattern formed on the silicone rubber blanket, a strap-shaped phase separation pattern appearing in a copolymer or the like is employed. The strap-shaped phase separation concavity and convexity pattern used in the present embodiment is structured such that a pitch of the concavity and convexity (a pitch between crests or between valleys) is between 1 and 12 micron, a depth of the concavity and convexity is between 0.1 and 0.8 micron, and a concavity and convexity film thickness is between 0.5 and 3.0 micron, and more preferably, the pitch of the concavity and convexity (the pitch between the crests or between the valleys) is between 3 and 8 micron, the depth of the concavity and convexity is between 0.2 and 0.6 micron, and the concavity and convexity film thickness is between 1.0 and 2.0 micron.

In this case, the strap-shaped phase separation concavity and convexity pattern is used, however, the same result can be obtained as well in the case of attaching the silicone rubber blanket 22 or the silicone sheet provided with the pattern in which a lot of circular micro convexities and concavities are arranged at random, to the cylinder 21.

Further, as an application of the present embodiment, in order to form the resin coated film having a higher accuracy, there is considered a structure in which the front surface of the wire bar 31 is treated by the silicone resin, the silicone rubber or the like, in the resin supplying unit 30 constituted by the wire bar coater. As a result, it is possible to improve the separation of the resin 32 from the wire bar 31, and it is possible to prevent the stringiness phenomenon from being generated, whereby it is possible to confirm that the film thickness unevenness of the resin 23 can be prevented from being generated.

Further, by applying the present embodiment, it is possible to provide a color liquid crystal display apparatus serving both as reflection and transmission and having a structure capable of displaying approximately the same color in the transmission and reflection display, by forming the concavity and convexity layer by a black matrix (the light shielding layer) and a color filter (red, green and blue), and laminating a transflective layer or a partial reflective layer, the black matrix and the color filter (red, green and blue).

In the case of forming the concavity and convexity layer for the reflecting diffuser in accordance with the pattern forming method of the present invention, the concavity and convexity pattern by the resin can be formed on the glass substrate, substantially only by one step of printing the resin pattern formed on the blanket to the glass substrate corresponding to the subject to be printed, not only it is possible to form the high performance built-in reflecting diffuser in which the concavity and convexity shape is controlled at a low cost, but also it is possible to provide a bright reflection type or a transflective liquid crystal display apparatus at a low cost.

Further, in accordance with the pattern forming method of the present invention, even in the case of the polymer film subject to be printed which is hard to be printed, the pattern having a high accuracy can be formed because a printability is not required with respect to the used resin.

Further, in accordance with the pattern forming method of the present invention, since it is possible to easily manufacture a pattern forming apparatus in which the roll-shaped continuous film can be used, it is possible to expect a wide productivity improvement in comparison with the method of printing on the glass substrate in accordance with the currently mainstream sheet-feeding method.

(Embodiment 3)

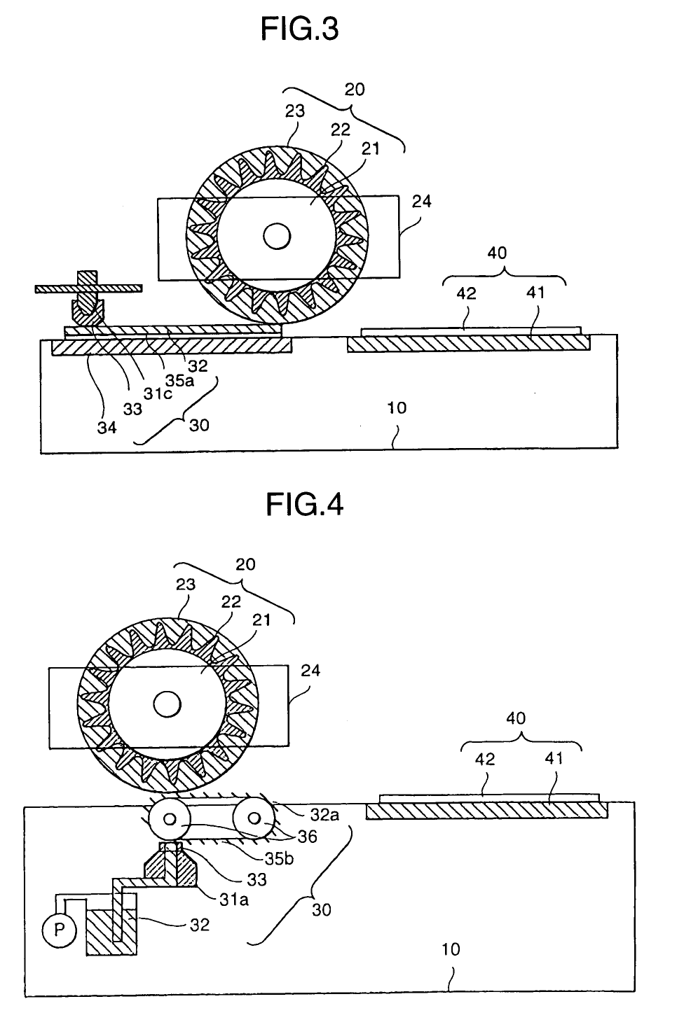

FIG. 3 shows the other embodiment of the concavity and convexity resin layer forming apparatus for the reflecting diffuser using the pattern forming method in accordance with the present invention. As shown in the drawing, a basic structure of the present invention is structured by the fixed frame 10, the pattern forming unit 20, the resin supplying unit 30, and the printing unit 40, and the transcribing principle and the apparatus structure are approximately the same as those of the embodiments 1 and 2 mentioned above, however, this embodiment is different from the embodiments 1 and 2 in a point that a blade 31c is used as the resin supplying unit 30.

The pattern forming apparatus of the present embodiment is structured by attaching the resin supplying unit 30 constituted by a resin coated film forming platen 34, a silicone sheet (a metal plate or a glass substrate having a silicone treated surface) 35a, a blade 31c in which a leading end portion is treated by the silicone resin 33 or the silicone rubber 33, and a resin reserving means (not shown), and the printing unit 40 constituted by the printing platen 41 and the glass substrate 42 constituted by the subject to be printed, to the fixed frame 10, and being provided with the cylinder 21 to which the blanket 22 having the printing plate function and the ink separating function is attached to the movable frame 24 for moving over the resin coated film forming platen 34 and the printing unit 40, on the fixed frame 10.

An operation of the pattern forming apparatus in accordance with the present apparatus is as follows. First, the present apparatus 1) stops the cylinder 21 to which the blanket 22 provided with the printing plate function and the ink separating function is attached, on the resin coated film forming platen 31, 2) rotates the blanket 22 provided with the printing plate function and the ink separating function on the front surface of the cylinder 21 while bringing into contact with the silicone sheet surface forming the resin coated film 32 by using the blade 31c in which the leading end portion is treated by the silicone resin 33 or the silicone rubber 33, thereby forming the resin coated film 23 having a predetermined thickness on the front surface of the blanket 22 having the printing plate function and the ink separating function, 3) moves the cylinder 21 on the printing platen 41, rolls the cylinder 21 in contact with the glass substrate 42 corresponding to the subject to be printed, and transcribes the resin 23 having the concavity and convexity pattern on the blanket 22 transcribed thereto to the glass substrate 42. Accordingly, the concavity and convexity resin layer for the reflecting diffuser can be formed by the minimum number of step.

Further, since it is possible to improve the resin separation from the blade 31c by coating the silicone resin 33 or the silicone rubber 33 on the front surface of the blade 31c, it is possible to uniformly and accurately form the film thickness of the resin coated film on the front surface of the blanket 22.

The resin 32 used in the present embodiment employs two kinds comprising a transparent acrylic or epoxy resin having no photosensitivity, and an opaque resin obtained by dispersing a color pigment to the transparent acrylic or epoxy resin. In the present embodiment, the concavity and convexity resin layer is formed by using not only the transparent resin corresponding to a transflective liquid crystal display provided with both a reflection portion and a transmission portion within one pixel, but also the resin obtained by dispersing the color pigment to the acrylic or epoxy resin, because of applying a function of corresponding to the structure in which the colored concavity and convexity resin layer serves as a light shielding layer, by patterning the reflective layer formed on the colored concavity and convexity resin layer. A black pigment is desirable for the pigment dispersed in this case.

Further, in the present embodiment, the silicone rubber blanket 22 having a lot of random micro concavities and convexities are employed as the blanket 22 provided with the printing plate function and the ink separating function, however, the same effect can be obtained as well in the case of employing a structure in which the silicone sheet having a lot of random concavities and convexities is attached to the cylinder 21.

Further, as the random concavity and convexity pattern, a phase separation pattern appearing in a high polymer block copolymer or the like is also employed. The phase separation concavity and convexity pattern used in the present embodiment is structured such that a pitch of the concavity and convexity (a pitch between crests or between valleys) is between 1 and 12 micron, a depth of the concavity and convexity is between 0.1 and 0.8 micron, and a concavity and convexity film thickness is between 0.5 and 3.0 micron, and more preferably, the pitch of the concavity and convexity (the pitch between the crests or between the valleys) is between 3 and 8 micron, the depth of the concavity and convexity is between 0.2 and 0.6 micron, and the concavity and convexity film thickness is between 1.0 and 2.0 micron.

In this case, the strap-shaped phase separation concavity and convexity pattern is used, however, the same result can be obtained as well in the case of attaching the silicone rubber blanket 22 or the silicone sheet provided with the pattern in which a lot of circular micro convexities and concavities are arranged at random, to the cylinder 21.

As an application of the present embodiment, in order to form the resin coated film having a higher accuracy, there is considered a structure in which the blade 31c is surface treated around a leading end portion by the silicone resin 33, the silicone rubber 33 or the like, in the resin coating unit 30 constituted by the blade. As a result, it is possible to improve the separation of the resin 32 from the blade 31c, and it is possible to prevent the stringiness phenomenon from being generated, whereby it is possible to confirm that the film thickness unevenness of the resin 32 can be prevented from being generated.

Further, by applying the present embodiment, it is possible to provide a color liquid crystal display apparatus serving both as reflection and transmission and having a structure capable of displaying approximately the same color in the transmission and reflection display, by forming the concavity and convexity layer by a black matrix (the light shielding layer) and a color filter (red, green and blue), and laminating a transflective layer or a partial reflective layer, the black matrix and the color filter (red, green and blue).

In the case of forming the concavity and convexity layer for the reflecting diffuser in accordance with the pattern forming method of the present invention, the concavity and convexity pattern by the resin can be formed on the glass substrate, substantially only by one step of printing the resin pattern formed on the blanket to the glass substrate corresponding to the subject to be printed, so that not only it is possible to form the high performance built-in reflecting diffuser in which the concavity and convexity shape is controlled at a low cost, but also it is possible to provide a bright reflection type or a transflective liquid crystal display apparatus at a low cost.

Further, in accordance with the pattern forming method of the present invention, even in the case of the polymer film subject to be printed which is hard to be printed, the pattern having a high accuracy can be formed because a printability is not required with respect to the used resin.

Further, in accordance with the pattern forming method of the present invention, since it is possible to easily manufacture a pattern forming apparatus in which the roll-shaped continuous film can be used, it is possible to expect a wide productivity improvement in comparison with the method of printing on the glass substrate in accordance with the currently mainstream sheet-feeding method.

(Embodiment 4)

FIG. 4 shows the other embodiment of the structure of the apparatus used for forming the concavity and convexity resin layer for the reflecting diffuser in accordance with the present invention. As shown in the drawing, a basic structure of the present invention is structured by the fixed frame 10, the pattern forming unit 20, the indirect mode resin supplying unit 30, and the printing unit 40, and the transcribing principle and the apparatus structure are approximately the same as those of the embodiments 1, 2 and 3 mentioned above, however, this embodiment is different from the embodiments 1, 2 and 3 in a point that an indirect coating method is used as the resin supplying unit 30.

The pattern forming apparatus of the present embodiment is structured by attaching the indirect mode resin supplying unit 30 based on the die coater provided with two expanding rolls 36 and a roll-shaped silicone sheet 35 (or a metal sheet made of stainless or the like to which a surface treatment is applied by the silicone resin, the silicone rubber, the silicone or the like), and the printing unit 40 constituted by the printing platen 41 and the glass substrate 42 constituted by the subject to be printed, to the fixed frame 10, and being provided with the cylinder 21 to which the blanket 22 having the printing plate function and the ink separating function is attached to the movable frame 24 for moving over a pattern forming and transcribing unit 20 and the printing unit 40, on the fixed frame 10.

An operation of the present apparatus is as follows. First, the present apparatus 1) stops the cylinder 21 to which the blanket 22 provided with the printing plate function and the ink separating function is attached, on the resin supplying unit 30, 2) brings the blanket 22 provided with the printing plate function and the ink separating function on the front surface of the cylinder 21 into contact with the front surface of the resin coated film 32a formed on the ring-shaped silicone sheet 35b having the ink separating function of the resin supplying unit 30 so as to rotate and drive them together, thereby forming the resin coated film 23 having a predetermined thickness on the front surface of the blanket 22 provided with the printing plate function and the ink separating function, 3) moves the blanket 22 on the printing platen 41, rolls the cylinder 21 in contact with the glass substrate 42 corresponding to the subject to be printed, and transcribes the resin 23 having the concavity and convexity pattern on the blanket 22 transcribed thereto to the glass substrate. Accordingly, the concavity and convexity resin layer for the reflecting diffuser can be formed by the minimum number of step.

In this case, in the present embodiment, the ring-shaped silicone sheet 35b is used as the base member for continuously driving or intermittently driving by the expanding roll, however, since it is possible to improve the resin separation from the base member forming the continuous running or intermittent running body even by employing the ring-shaped metal sheet, for example, made of stainless or the like obtained by coating the silicone resin, the silicone rubber or the silicone on the front surface, it is possible to uniformly and accurately form the film thickness of the resin coated film on the front surface of the blanket.

The resin 32 used in the present embodiment employs two kinds comprising a transparent acrylic or epoxy resin having no photosensitivity, and an opaque resin obtained by dispersing a color pigment to the transparent acrylic or epoxy resin. In the present embodiment, the concavity and convexity resin layer is formed by using not only the transparent resin corresponding to a transflective liquid crystal display provided with both a reflection portion and a transmission portion within one pixel, but also the resin obtained by dispersing the color pigment to the acrylic or epoxy resin, because of applying a function of corresponding to the structure in which the colored concavity and convexity resin layer serves as a light shielding layer, by patterning the reflective layer formed on the colored concavity and convexity resin layer. A black pigment is desirable for the pigment dispersed in this case.

Further, in the present embodiment, the silicone rubber blanket 22 having a lot of random micro concavities and convexities are employed as the blanket 22 provided with the printing plate function and the ink separating function, however, the same effect can be obtained as well in the case of employing a structure in which the silicone sheet having a lot of random concavities and convexities is attached to the cylinder 21.

Further, as the random concavity and convexity pattern, a phase separation pattern appearing in a high polymer block copolymer or the like is also employed. The phase separation concavity and convexity pattern used in the present embodiment is structured such that a pitch of the concavity and convexity (a pitch between crests or between valleys) is between 1 and 12 micron, a depth of the concavity and convexity is between 0.1 and 0.8 micron, and a concavity and convexity film thickness is between 0.5 and 3.0 micron, and more preferably, the pitch of the concavity and convexity (the pitch between the crests or between the valleys) is between 3 and 8 micron, the depth of the concavity and convexity is between 0.2 and 0.6 micron, and the concavity and convexity film thickness is between 1.0 and 2.0 micron.

In this case, the strap-shaped phase separation concavity and convexity pattern is used, however, the same result can be obtained as well in the case of attaching the silicone rubber blanket 22 or the silicone sheet provided with the pattern in which a lot of circular micro convexities and concavities are arranged at random, to the cylinder 21.

As an application of the present embodiment, in order to form the resin coated film having a higher accuracy, there is considered a structure in which the die coater head 31a is surface treated around a discharge port by the silicone resin 33, the silicone rubber 33 or the like, in the resin coating unit 30 constituted by the die coater. As a result, it is possible to improve the separation of the resin 32 from the die coater 31a, and it is possible to prevent the stringiness phenomenon from being generated, whereby it is possible to confirm that the film thickness unevenness of the resin 32 can be prevented from being generated.

On the basis of the same principle, it is possible to form the resin coated film 23 having a uniform film thickness on the front surface of the blanket 22 without generating the stringiness phenomenon on the resin coated film 32a on the ring-shaped silicone sheet 35b.

Further, by applying the present embodiment, it is possible to provide a color liquid crystal display apparatus serving both as reflection and transmission and having a structure capable of displaying approximately the same color in the transmission and reflection display, by forming the concavity and convexity layer by a black matrix (the light shielding layer) and a color filter (red, green and blue), and laminating a transflective layer or a partial reflective layer, the black matrix and the color filter (red, green and blue).

In the case of forming the concavity and convexity layer for the reflecting diffuser in accordance with the pattern forming method of the present invention, the concavity and convexity pattern by the resin can be formed on the glass substrate, substantially only by one step of printing the resin pattern formed on the blanket to the glass substrate corresponding to the subject to be printed. Accordingly, not only it is possible to form the high performance built-in reflecting diffuser in which the concavity and convexity shape is controlled at a low cost, but also it is possible to provide a bright reflection type or a transflective liquid crystal display apparatus at a low cost.

Further, in accordance with the pattern forming method of the present invention, even in the case of the polymer film subject to be printed which is hard to be printed, the pattern having a high accuracy can be formed because a printability is not required with respect to the used resin.

Further, in accordance with the pattern forming method of the present invention, since it is possible to easily manufacture a pattern forming apparatus in which the roll-shaped continuous film can be used, it is possible to expect a wide productivity improvement in comparison with the method of printing on the glass substrate in accordance with the currently mainstream sheet-feeding method.

(Embodiment 5)

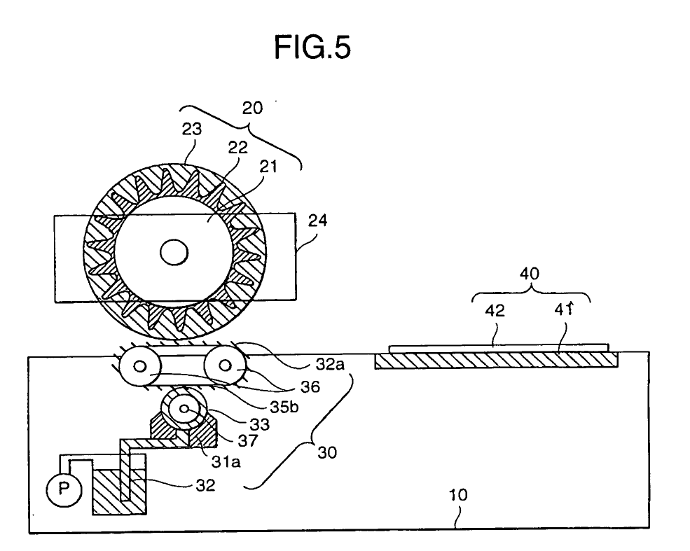

FIG. 5 shows the other embodiment of the structure of the apparatus used for forming the concavity and convexity resin layer for the reflecting diffuser in accordance with the present invention. As shown in the drawing, a basic structure of the present invention is structured by the fixed frame 10, the pattern forming unit 20, the resin supplying unit 30, and the printing unit 40, and the transcribing principle and the apparatus structure are approximately the same as those of the embodiments 1, 2, 3 and 4 mentioned above, however, this embodiment is different from the embodiments 1, 2 and 3 in a point that an indirect coating method is used as the resin supplying unit 30, and is different from the embodiment 4 in a point that a gravure coater is employed as the resin supplying unit.

The pattern forming apparatus of the present embodiment is structured by attaching the indirect mode resin supplying unit 30 based on the gravure coater provided with two expanding rolls 36 and a ring-shaped silicone sheet 35b (or a metal sheet made of stainless or the like to which a surface treatment is applied by the silicone resin, the silicone rubber, the silicone or the like), and the printing unit 40 constituted by the printing platen 41 and the glass substrate 42 constituted by the subject to be printed, to the fixed frame 10, and being provided with the cylinder 21 to which the blanket 22 having the printing plate function and the ink separating function is attached to the movable frame 24 for moving over a pattern forming and transcribing unit 20 and the printing unit 40, on the fixed frame 10.

An operation of the present apparatus is as follows. First, the present apparatus 1) stops the cylinder 21 to which the blanket 22 provided with the printing plate function and the ink separating function is attached, on the resin supplying unit 30, 2) brings the blanket 22 provided with the printing plate function and the ink separating function on the front surface of the cylinder 21 into contact with the front surface of the resin coated film 32a formed on the silicone sheet 35b having the ink separating function of the resin supplying unit 30 so as to rotate and drive them together, thereby forming the resin coated film 23 having a predetermined thickness on the front surface of the blanket 22 provided with the printing plate function and the ink separating function, 3) moves the blanket 22 on the printing platen 41, rolls the cylinder 21 in contact with the glass substrate 42 corresponding to the subject to be printed, and transcribes the resin 23 having the concavity and convexity pattern on the blanket 22 transcribed thereto to the glass substrate. Accordingly, the concavity and convexity resin layer for the reflecting diffuser can be formed by the minimum number of step.

In this case, in the present embodiment, the ring-shaped silicone sheet 35b is used as the base member for continuously driving or intermittently driving by the expanding roll 36, however, since it is possible to improve the resin separation from the base member forming the continuous running or intermittent running body even by employing the ring-shaped metal sheet, for example, made of stainless or the like obtained by coating the silicone resin, the silicone rubber or the silicone on the front surface, it is possible to uniformly and accurately form the film thickness of the resin coated film 23 on the front surface of the blanket.

The resin 32 used in the present embodiment employs two kinds comprising a transparent acrylic or epoxy resin having no photosensitivity, and an opaque resin obtained by dispersing a color pigment to the transparent acrylic or epoxy resin. In the present embodiment, the concavity and convexity resin layer is formed by using not only the transparent resin corresponding to a transflective liquid crystal display provided with both a reflection portion and a transmission portion within one pixel, but also the resin obtained by dispersing the color pigment to the acrylic or epoxy resin, because of applying a function of corresponding to the structure in which the colored concavity and convexity resin layer serves as a light shielding layer, by patterning the reflective layer formed on the colored concavity and convexity resin layer. A black pigment is desirable for the pigment dispersed in this case.

Further, in the present embodiment, the silicone rubber blanket 22 having a lot of random micro concavities and convexities are employed as the blanket 22 provided with the printing plate function and the ink separating function, however, the same effect can be obtained as well in the case of employing a structure in which the silicone sheet having a lot of random concavities and convexities is attached to the cylinder 21.

Further, as the random concavity and convexity pattern, a phase separation pattern appearing in a high polymer block copolymer or the like is also employed. The phase separation concavity and convexity pattern used in the present embodiment is structured such that a pitch of the concavity and convexity (a pitch between crests or between valleys) is between 1 and 12 micron, a depth of the concavity and convexity is between 0.1 and 0.8 micron, and a concavity and convexity film thickness is between 0.5 and 3.0 micron, and more preferably, the pitch of the concavity and convexity (the pitch between the crests or between the valleys) is between 3 and 8 micron, the depth of the concavity and convexity is between 0.2 and 0.6 micron, and the concavity and convexity film thickness is between 1.0 and 2.0 micron.

In this case, the strap-shaped phase separation concavity and convexity pattern is used, however, the same result can be obtained as well in the case of attaching the silicone rubber blanket 22 or the silicone sheet provided with the pattern in which a lot of circular micro convexities and concavities are arranged at random, to the cylinder 21.

As an application of the present embodiment, in order to form the resin coated film having a higher accuracy, there is considered a structure in which the front surface of the gravure roll 37 is surface treated by the silicone resin 33, the silicone rubber 33 or the like, in the resin coating unit 30 constituted by the gravure coater provided with the gravure roll 37. As a result, it is possible to improve the separation of the resin 32a from the gravure roll 37, and it is possible to prevent the stringiness phenomenon from being generated, whereby it is possible to confirm that the film thickness unevenness of the resin 32a formed on the ring-shaped silicone sheet 35b and the resin 32 formed on the blanket 22 can be prevented from being generated.

Further, by applying the present embodiment, it is possible to provide a color liquid crystal display apparatus serving both as reflection and transmission and having a structure capable of displaying approximately the same color in the transmission and reflection display, by forming the concavity and convexity layer by a black matrix (the light shielding layer) and a color filter (red, green and blue), and laminating a transflective layer or a partial reflective layer, the black matrix and the color filter (red, green and blue).

In the case of forming the concavity and convexity layer for the reflecting diffuser in accordance with the pattern forming method of the present invention, the concavity and convexity pattern by the resin can be formed on the glass substrate, substantially only by one step of printing the resin pattern formed on the blanket to the glass substrate corresponding to the subject to be printed. Accordingly, not only it is possible to form the high performance built-in reflecting diffuser in which the concavity and convexity shape is controlled at a low cost, but also it is possible to provide a bright reflection type or a transflective liquid crystal display apparatus at a low cost.

Further, in accordance with the pattern forming method of the present invention, even in the case of the polymer film subject to be printed which is hard to be printed, the pattern having a high accuracy can be formed because a printability is not required with respect to the used resin.

Further, in accordance with the pattern forming method of the present invention, since it is possible to easily manufacture a pattern forming apparatus in which the roll-shaped continuous film can be used, it is possible to expect a wide productivity improvement in comparison with the method of printing on the glass substrate in accordance with the currently mainstream sheet-feeding method.

(Embodiment 6)

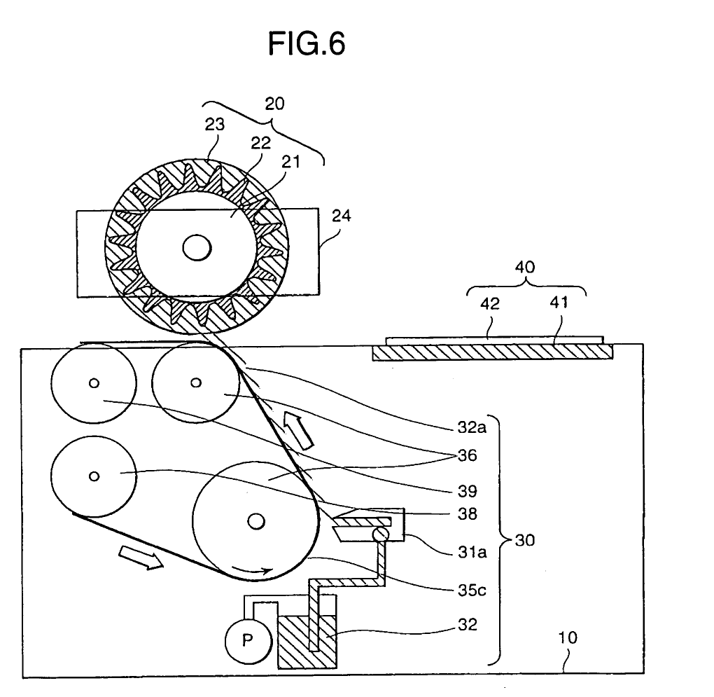

FIG. 6 shows the other embodiment of the structure of the apparatus used for forming the concavity and convexity resin layer for the reflecting diffuser in accordance with the present invention. As shown in the drawing, a basic structure of the present invention is structured by the fixed frame 10, the pattern forming unit 20, the resin supplying unit 30, and the printing unit 40. The transcribing principle and the apparatus structure are approximately the same as those of the embodiments 1, 2, 3, 4 and 5 mentioned above. This embodiment is different from the embodiments 1, 2 and 3 in a point that an indirect coating method is used as the resin supplying unit 30, and is different from the embodiments 4 and 5 in a point that a die coater using a roll-shaped continuous sheet 35c (a silicone sheet) is employed as the resin supplying unit 30.

The pattern forming apparatus of the present embodiment is structured by attaching the indirect mode resin supplying unit 30 based on the die coater provided with two expanding rolls 36, a feeding roll 38, a take-up roll 39 and a silicone sheet 35c (or a metal sheet made of stainless or the like to which a surface treatment is applied by the silicone resin, the silicone rubber or the like), and the printing unit 40 constituted by the printing platen 41 and the glass substrate 42 constituted by the subject to be printed, to the fixed frame 10, and being provided with the cylinder 21 to which the blanket 22 having the printing plate function and the ink separating function is attached to the movable frame 24 for moving over a pattern forming and transcribing unit 20 and the printing unit 40, on the fixed frame 10.

An operation of the present apparatus is as follows. First, the present apparatus 1) stops the cylinder 21 to which the blanket 22 provided with the printing plate function and the ink separating function is attached, on the resin supplying unit 30, 2) brings the blanket 22 provided with the printing plate function and the ink separating function on the front surface of the cylinder 21 into contact with the front surface of the resin coated film 32a formed on the silicone sheet 35 having the ink separating function of the resin supplying unit 30 so as to rotate and drive them together, thereby forming the resin coated film 23 having a predetermined thickness on the front surface of the blanket 22 provided with the printing plate function and the ink separating function, 3) moves the blanket 22 on the printing platen 41, rolls the cylinder 21 in contact with the glass substrate 42 corresponding to the subject to be printed, and transcribes the resin 23 having the concavity and convexity pattern on the blanket 22 transcribed thereto to the glass substrate. Accordingly, the concavity and convexity resin layer for the reflecting diffuser can be formed by the minimum number of step.

In this case, in the present embodiment, the S-34 silicone sheet (manufactured by TEIJIN CO. LTD) is used as the silicone sheet wound around the roll forming the base member for continuously driving or intermittently driving by the expanding roll 36, however, the present invention is not limited to this material, and as far as the material has a good separation property from the used material such as the resin, the ink or the like, the resin coated film 23 formed on the front surface of the blanket can be uniformly and accurately formed. Since it is possible to improve the resin separation from the base member forming the continuous running or intermittent running body even by employing the belt-shaped metal sheet, for example, made of stainless or the like obtained by coating the silicone resin, the silicone rubber or the silicone on the front surface, it is possible to uniformly and accurately form the film thickness of the resin coated film on the front surface of the blanket.

Further, in the embodiment, the die coater head 31a applying a predetermined amount of resin is positioned on the expanding roll 36, however, the resin coated film having the same accuracy can be obtained even by arranging the die coater head 31a between two expanding rolls.

The resin 32 used in the present embodiment employs two kinds comprising a transparent acrylic or epoxy resin having no photosensitivity, and an opaque resin obtained by dispersing a color pigment to the transparent acrylic or epoxy resin. In the present embodiment, the concavity and convexity resin layer is formed by using not only the transparent resin corresponding to a transflective liquid crystal display provided with both a reflection portion and a transmission portion within one pixel, but also the resin obtained by dispersing the color pigment to the acrylic or epoxy resin, because of applying a function of corresponding to the structure in which the colored concavity and convexity resin layer serves as a light shielding layer, by patterning the reflective layer formed on the colored concavity and convexity resin layer. A black pigment is desirable for the pigment dispersed in this case.

Further, in the present embodiment, the silicone rubber blanket 22 having a lot of random micro concavities and convexities are employed as the blanket 22 provided with the printing plate function and the ink separating function, however, the same effect can be obtained as well in the case of employing a structure in which the silicone sheet having a lot of random concavities and convexities is attached to the cylinder 21.

Further, as the random concavity and convexity pattern, a phase separation pattern appearing in a high polymer block copolymer or the like is also employed. The phase separation concavity and convexity pattern used in the present embodiment is structured such that a pitch of the concavity and convexity (a pitch between crests or between valleys) is between 1 and 12 micron, a depth of the concavity and convexity is between 0.1 and 0.8 micron, and a concavity and convexity film thickness is between 0.5 and 3.0 micron, and more preferably, the pitch of the concavity and convexity (the pitch between the crests or between the valleys) is between 3 and 8 micron, the depth of the concavity and convexity is between 0.2 and 0.6 micron, and the concavity and convexity film thickness is between 1.0 and 2.0 micron.

In this case, the strap-shaped phase separation concavity and convexity pattern is used, however, the same result can be obtained as well in the case of attaching the silicone rubber blanket 22 or the silicone sheet provided with the pattern in which a lot of circular micro convexities and concavities are arranged at random, to the cylinder 21.

As an application of the present embodiment, in order to form the resin coated film having a higher accuracy, there is considered a structure in which the die coater head 31 is surface treated around the discharge port by the silicone resin, the silicone rubber, the silicone or the like, in the resin coating unit 30 constituted by the die coater. As a result, it is possible to improve the separation of the resin 32 from the die coater head 31, and it is possible to prevent the stringiness phenomenon from being generated, whereby it is possible to confirm that the film thickness unevenness of the resin 32 can be prevented from being generated.

Further, by applying the present embodiment, it is possible to provide a color liquid crystal display apparatus serving both as reflection and transmission and having a structure capable of displaying approximately the same color in the transmission and reflection display, by forming the concavity and convexity layer by a black matrix (the light shielding layer) and a color filter (red, green and blue), and laminating a transflective layer or a partial reflective layer, the black matrix and the color filter (red, green and blue).

In the case of forming the concavity and convexity layer for the reflecting diffuser in accordance with the pattern forming method of the present invention, the concavity and convexity pattern by the resin can be formed on the glass substrate, substantially only by one step of printing the resin pattern formed on the blanket to the glass substrate corresponding to the subject to be printed. Accordingly, not only it is possible to form the high performance built-in reflecting diffuser in which the concavity and convexity shape is controlled at a low cost, but also it is possible to provide a bright reflection type or a transflective liquid crystal display apparatus at a low cost.

Further, in accordance with the pattern forming method of the present invention, even in the case of the polymer film subject to be printed which is hard to be printed, the pattern having a high accuracy can be formed because a printability is not required with respect to the used resin.

Further, in accordance with the pattern forming method of the present invention, since it is possible to easily manufacture a pattern forming apparatus in which the roll-shaped continuous film can be used, it is possible to expect a wide productivity improvement in comparison with the method of printing on the glass substrate in accordance with the currently mainstream sheet-feeding method.

(Embodiment 7)

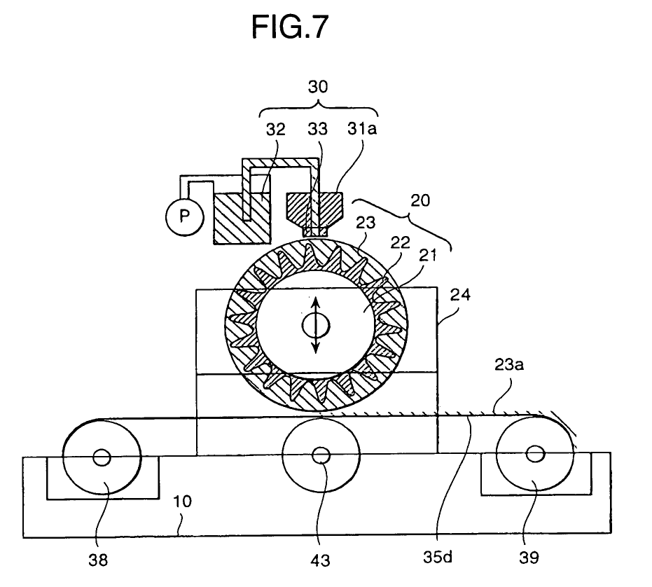

FIG. 7 shows the other embodiment of the structure of the apparatus used for forming the concavity and convexity resin layer for the reflecting diffuser in accordance with the present invention. As shown in the drawing, a basic structure of the present invention is structured by the fixed frame 10, the pattern forming unit 20, the resin supplying unit 30, and the pattern transcribing unit 40. The transcribing principle and the apparatus structure are approximately the same as those of the embodiments 1, 2, 3, 4, 5 and 6 mentioned above, however, this embodiment is different from the embodiments 1, 2, 3, 4, 5 and 6 in a point that a roll-shaped continuous sheet is employed as the subject to be printed in the printing unit 40.

The pattern forming apparatus of the present embodiment is structured such that the fixed frame 10 is provided with the pattern forming and transcribing unit 20 in which the blanket having the printing plate function and the ink separating function is attached to the cylinder 21, the resin supplying unit 30 constituted by the die coater, the feeding roll 38, the take-up roll 39, and the pattern transcribing unit 40 constituted by an ultraviolet irradiating means 43 and a silicone sheet 35 (or a high polymer sheet to which the surface treatment is applied by the silicone resin, the silicone rubber or the like) corresponding to the subject to be printed.

An operation of the present apparatus is as follows. First, the present apparatus 1) discharges such an amount of resin as to achieve a predetermined film thickness from the die coater head portion 31 of the resin supplying unit 30 while interlocking with the rotation of the cylinder 21 to which the blanket 22 provided with the printing plate function and the ink separating function is attached, forms the resin coated film 23 on the blanket 22, simultaneously transcribes the concavity and convexity pattern formed on the blanket 22 to the resin coated film 23, transcribes to a plastic sheet 35 (a polysulphone group, a polyether sulphone group, a polyether imide group, a polyether ketone group, a polycarbonate group, an epoxy group or the like) corresponding to the subject to be printed traveling in an interlocking manner while rotating, and hardening the resin by the ultraviolet irradiating means 60. Accordingly, the concavity and convexity resin layer for the reflecting diffuser can be formed by the minimum number of step.

In this case, in the present embodiment, the structure (width: 270 to 1200 mm, thickness: 100 to 400 μm, length: 50 to 400 m) made of the polysulphone group, the polyether sulphone group, the polyether imide group, the polyether ketone group, the polycarbonate group, the epoxy group or the like wound around the roll is used as the plastic sheet for continuously driving or intermittently driving by the feeding roll 38 and the take-up roll 39, however, the present invention is not limited to this material, and any material which can be used as a substrate for the liquid crystal display may be employed.

The resin 32 used in the present embodiment employs two kinds comprising a transparent acrylic or epoxy resin having no photosensitivity, and an opaque resin obtained by dispersing a color pigment to the transparent acrylic or epoxy resin. In the present embodiment, the concavity and convexity resin layer is formed by using not only the transparent resin corresponding to a transflective liquid crystal display provided with both a reflection portion and a transmission portion within one pixel, but also the resin obtained by dispersing the color pigment to the acrylic or epoxy resin, because of applying a function of corresponding to the structure in which the colored concavity and convexity resin layer serves as a light shielding layer, by patterning the reflective layer formed on the colored concavity and convexity resin layer. A black pigment is desirable for the pigment dispersed in this case.

Further, in the present embodiment, the silicone rubber blanket 22 having a lot of random micro concavities and convexities are employed as the blanket 22 provided with the printing plate function and the ink separating function, however, the same effect can be obtained as well in the case of employing a structure in which the silicone sheet having a lot of random concavities and convexities is attached to the cylinder 21.

Further, as the random concavity and convexity pattern, a phase separation pattern appearing in a high polymer block copolymer or the like is also employed. The phase separation concavity and convexity pattern used in the present embodiment is structured such that a pitch of the concavity and convexity (a pitch between crests or between valleys) is between 1 and 12 micron, a depth of the concavity and convexity is between 0.1 and 0.8 micron, and a concavity and convexity film thickness is between 0.5 and 3.0 micron, and more preferably, the pitch of the concavity and convexity (the pitch between the crests or between the valleys) is between 3 and 8 micron, the depth of the concavity and convexity is between 0.2 and 0.6 micron, and the concavity and convexity film thickness is between 1.0 and 2.0 micron.

In this case, the strap-shaped phase separation concavity and convexity pattern is used, however, the same result can be obtained as well in the case of attaching the silicone rubber blanket 22 or the silicone sheet provided with the pattern in which a lot of circular micro convexities and concavities are arranged at random, to the cylinder 21.

As an application of the present embodiment, in order to form the resin coated film having a higher accuracy, there is considered a structure in which the die coater head 31 is surface treated around the discharge port by the silicone resin, the silicone rubber, the silicone or the like, in the resin coating unit 30 constituted by the die coater. As a result, it is possible to improve the separation of the resin 32 from the die coater head 31, and it is possible to prevent the stringiness phenomenon from being generated, whereby it is possible to confirm that the film thickness unevenness of the resin 32 can be prevented from being generated.

Further, by applying the present embodiment, it is possible to provide a color liquid crystal display apparatus serving both as reflection and transmission and having a structure capable of displaying approximately the same color in the transmission and reflection display, by forming the concavity and convexity layer by a black matrix (the light shielding layer) and a color filter (red, green and blue), and laminating a transflective layer or a partial reflective layer, the black matrix and the color filter (red, green and blue).

In the case of forming the concavity and convexity layer for the reflecting diffuser in accordance with the pattern forming method of the present invention, the concavity and convexity pattern by the resin can be formed on the glass substrate, substantially only by one step of printing the resin pattern formed on the blanket to the glass substrate corresponding to the subject to be printed. Accordingly, not only it is possible to form the high performance built-in reflecting diffuser in which the concavity and convexity shape is controlled at a low cost, but also it is possible to provide a bright reflection type or a transflective liquid crystal display apparatus at a low cost.

Further, in accordance with the pattern forming method of the present invention, even in the case of the polymer film subject to be printed which is hard to be printed, the pattern having a high accuracy can be formed because a printability is not required with respect to the used resin.

Further, in accordance with the pattern forming method of the present invention, since it is possible to easily manufacture a pattern forming apparatus in which the roll-shaped continuous film can be used, it is possible to expect a wide productivity improvement in comparison with the method of printing on the glass substrate in accordance with the currently mainstream sheet-feeding method.

(Embodiment 8)

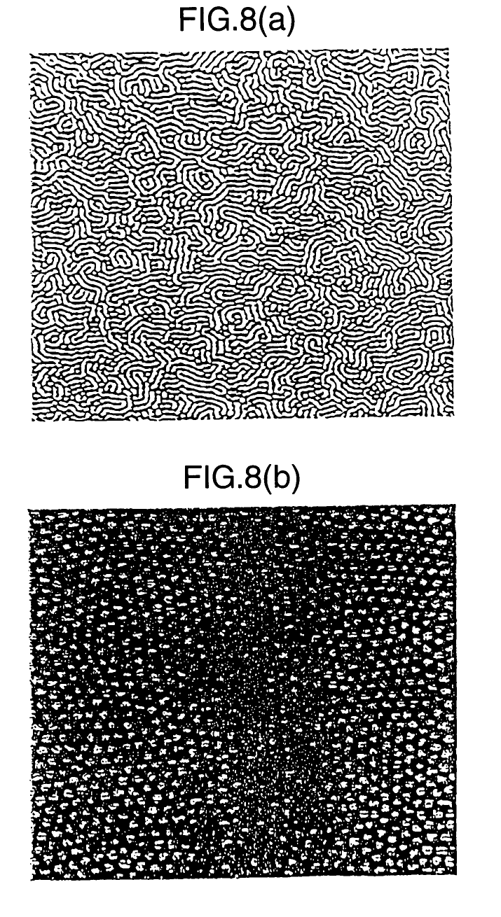

FIGS. 8 to 11 show an embodiment of a blanket for a built-in reflecting diffuser used in the pattern forming method in accordance with the present invention. FIGS. 8(a) and 8(b) are views showing the concavity and convexity pattern formed on the front surface of the blanket, in which FIG. 8(a) shows the strap-shaped phase separation pattern appearing in the high polymer block copolymer or the like, and FIG. 8(b) shows the circular phase separation pattern. Both the patterns are the random patterns without regularity (non-directional with respect to an azimuth direction) and are preferable as the concavity and convexity of the reflecting diffuser.

In this case, a pitch of the concavity and convexity (a pitch between crests or between valleys) of the patterns shown in FIGS. 8(a) and 8(b) is between 1 and 12 micron, a depth of the concavity and convexity is between 0.1 and 0.8 micron, and a concavity and convexity film thickness is between 0.5 and 3.0 micron, and more preferably, the pitch of the concavity and convexity (the pitch between the crests or between the valleys) is between 3 and 8 micron, the depth of the concavity and convexity is between 0.2 and 0.6 micron, and the concavity and convexity film thickness is between 1.0 and 2.0 micron. Accordingly, the small depth is achieved and it is possible to obtain the reflecting diffuser which is effective for uniformizing the thickness of the liquid crystal.

Since it is possible to create the pattern in accordance with a computer simulation using Cell-dynamical System Model for analyzing the phase separation phenomenon of the high polymer block copolymer on the basis of these patterns and variously control the pattern such as with or without directivity, a rate of the concavity and convexity width and the like, it is possible to manufacture a photo mask which can optionally control a light scattering property as the reflecting diffuser.

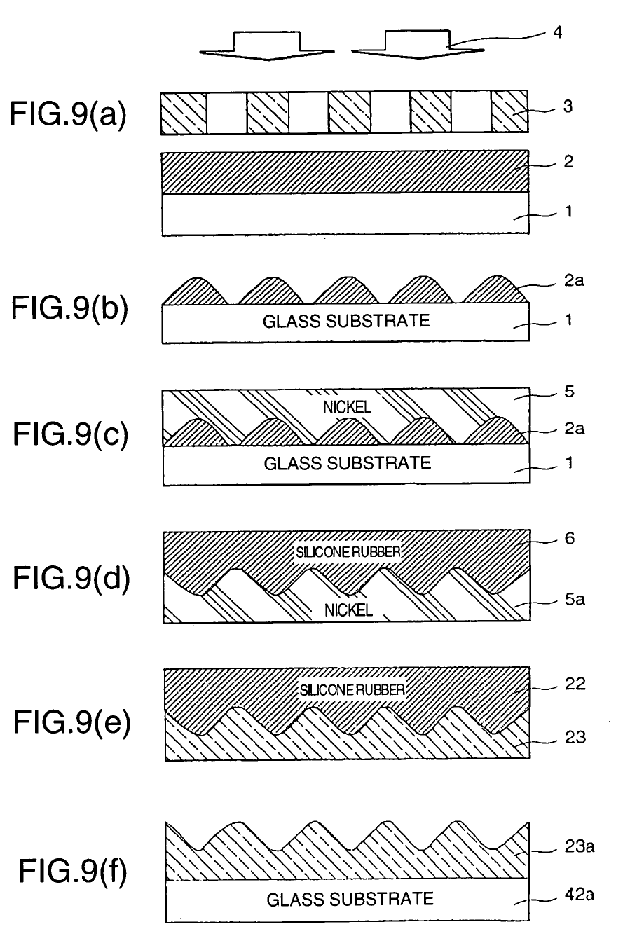

FIGS. 9(a) to 9(f) are schematic views showing preparation of the silicone rubber blanket using the photo mask and formation of the resin pattern. FIG. 9(a) shows a step of irradiating the ultraviolet ray onto the photosensitive resin coated film 2 formed on the glass substrate 1 via the photo mask 3 for the phase separation pattern, FIG. 9(b) shows a step of forming the continuous micro concavity and convexity resin layer 2a (refer to the pattern in FIG. 8) having a predetermined cross sectional shape by developing and heating the photosensitive resin coated film 2 in accordance with a predetermined condition, FIG. 9(c) shows a step of forming a conductive layer (not shown, a conductive thin film in accordance with a sputter method or the like, or a conductive coating material such as a silver paste or the like) on the concavity and convexity resin layer 2a, and forming a nickel layer 5 to which the concavity and convexity pattern of the resin layer is transcribed in accordance with an electrolytic plating method, FIG. 9(d) is a step of forming the silicone rubber blanket 22 having the micro convexity and concavity by filling in and hardening the silicone rubber 6 on the nickel layer 5 having the concavity and convexity pattern formed thereon by using a mold form or the like, FIG. 9(e) shows a step of forming the resin coated film 23 on the silicone rubber blanket 22 provided with the micro concavity and convexity, and simultaneously forming the micro concavity and convexity pattern on the resin coated film 23, and FIG. 9(f) shows a step of forming the concavity and convexity resin layer 23 by transcribing and hardening the resin formed on the blanket 22 to the glass substrate 42 corresponding to the subject to be printed. The pattern forming method is structured such as to form the concavity and convexity resin layer for the reflection type or semi-permeable type liquid crystal reflecting diffuser, in accordance with the above-mentioned steps.

In this case, the reflecting diffuser is completed by forming the reflective layer-(film thickness: 1000 to 2000 Å) or the transflective layer (film thickness: 100 to 500 Å) made of an aluminum, an aluminum alloy, a silver, a silver alloy and the like on the concavity and convexity resin layer 23 in accordance with a sputter method or the like.

In the present embodiment, the concavity and convexity resin layer 2a is formed on the glass substrate 42 by forming a resin mother mold by the photosensitive resin 2, transcribing the resin mother mold by the nickel 5 in accordance with a nickel plating method, and forming the blanket 22 by the silicone rubber 6 in an injection mold, however, the present invention is not limited to this, and a structure (the resin is easily peeled) obtained by forming the continuous micro concavity and convexity resin layer 2a (refer to the pattern in FIG. 8) having the predetermined cross sectional shape by exposing, developing and heating on the high polymer sheet having the silicone resin coated thereon by using the photo mask may be wound around the cylinder and used.

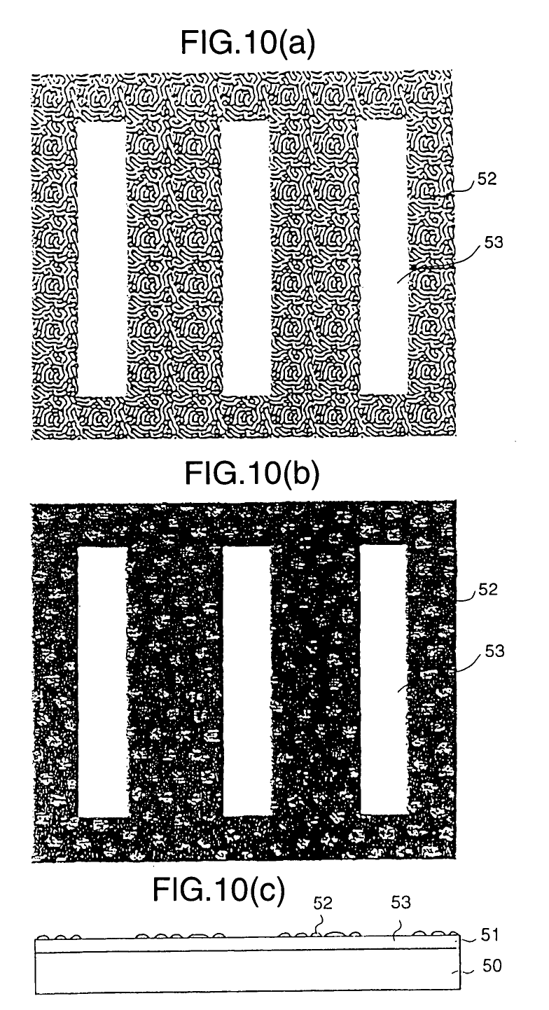

FIGS. 10(a) and 10(b) show a photo mask pattern for the reflecting diffuser in which one pixel is constituted by the transmission portion and the reflection portion and serves both as the transmission display and the reflection display. FIG. 10(a) shows a concavity and convexity pattern constituted by a reflection portion 52 provided with the micro concavity and convexity comprising the strap-shaped phase separation pattern mentioned above, and a transmission portion 53 having no reflective layer, FIG. 10(b) shows a photo mask pattern constituted by the reflection portion 52 provided with the micro concavity and convexity comprising the circular phase separation pattern mentioned above, and the transmission portion 53 having no reflective layer, and FIG. 10(c) shows a cross sectional structure of the concavity and convexity resin layer formed by using the photo mask shown in FIGS. 10(a) and 10(b), in which the concavity and convexity portion 52 and the flat portion 53 are formed on the photosensitive resin layer 51 on the glass substrate 50.

In this case, in the present embodiment, the transmission portion 53 is provided with no concavity and convexity and is formed in a flat shape, however, in the small depth concavity and convexity constituted by the phase separation pattern in accordance with the present embodiment, the display property approximately the same as that of the flat shape can be obtained even in the case that the concavity and convexity exists in the transmission portion 53.

Further, a positive type photosensitive resin is used in the present embodiment, however, the same concavity and convexity resin layer can be formed by using a photo mask obtained by reversing the transmission portion (a white part in FIG. 10) and a light shielding portion (a black part in FIG. 10) even in a negative type photosensitive resin.

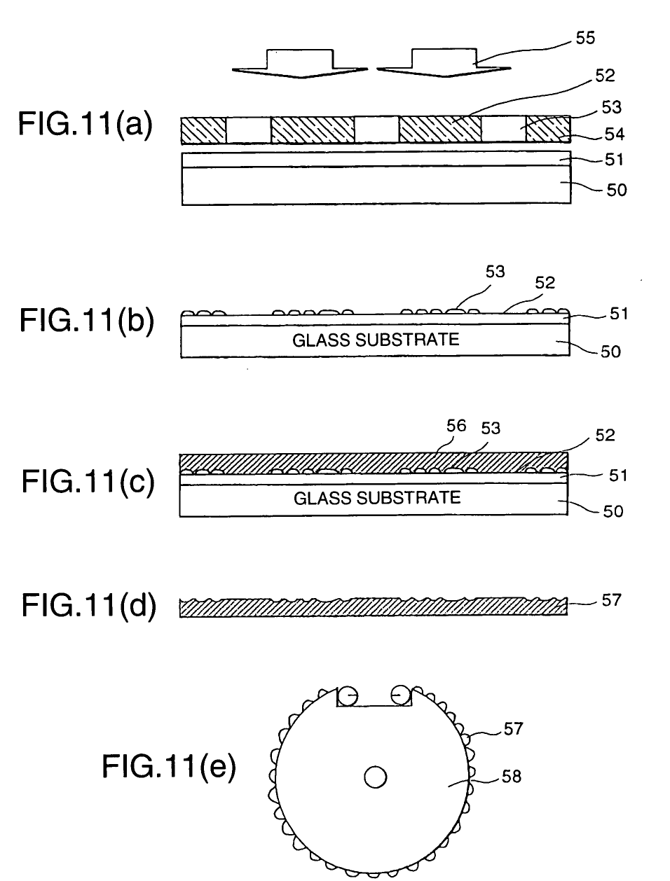

FIGS. 11(a) to 11(e) are schematic cross sectional views showing formation of the blanket for the reflecting diffuser serving both as the transmission display and the reflection display mentioned above. The blanket forming process is constituted by a step (FIG. 11(a)) of irradiating an ultraviolet ray 55 onto the glass substrate 50 to which the positive type photosensitive resin 51 is coated, via a photo mask 54 in which the white and black parts are reversed in accordance with the pattern shown in FIGS. 10(a) and 10(b), a step (FIG. 11(b)) of forming the micro concavity and convexity portion 52 and the transmission portion 53 corresponding to the flat portion having no micro concavity and convexity in accordance with a predetermined developing and heating (a melt method), and a step (FIG. 11(c)) of injecting and hardening a silicone rubber 56 on the concavity and convexity resin layer 51 constituted by the reflection portion 52 corresponding to the concavity and convexity portion and the transmission portion 53 corresponding to the flat portion by using an outer frame or the like. Accordingly, a blanket 57 having the micro reflection portion 52 constituted by the silicone rubber 56 and the transmission portion 53 corresponding to the flat portion is completed (FIG. 11(d)).

In this case, the present embodiment shows the method of forming the blanket by the silicone rubber, however, the concavity and convexity for the reflecting diffuser serving both as the transmission display and the reflection display may be directly formed by the positive type photosensitive silicone resin on the high polymer sheet by using the photo mask 54, and the same performance as that of the reflecting diffuser formed by the silicone rubber can be obtained even in the case that the high polymer sheet having the silicone resin micro concavity and convexity formed thereon is used in a state of being wound around the cylinder.

In the present embodiment, as shown in FIG. 11(e), the printing plate function and the ink separating function are applied to the blanket by attaching the blanket 57 constituted by the silicone rubber 56 or the blanket constituted by the silicone resin and the high polymer sheet to the cylinder 58, whereby it is possible to form the high-performance reflecting diffuser for displaying the reflection or displaying both the reflection and the transmission at a low cost.

(Embodiment 9)

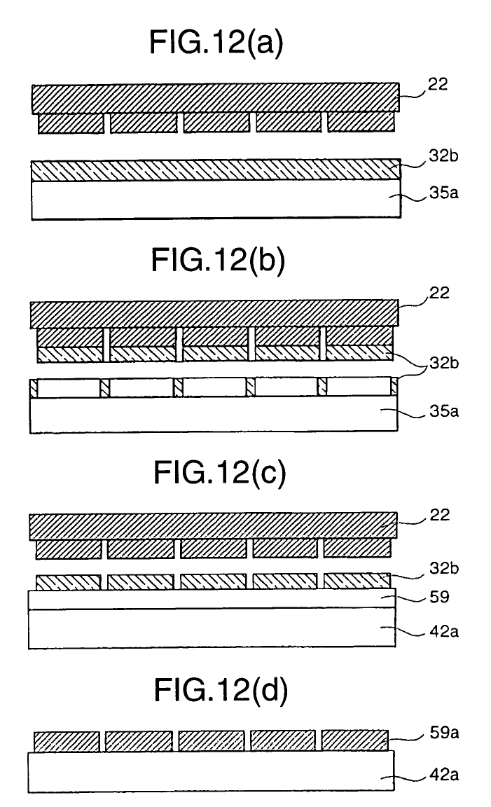

FIGS. 12 to 16 show an embodiment of a liquid crystal display apparatus for displaying the reflection and displaying both the reflection and the transmission using the pattern forming method in accordance with the present invention. FIGS. 12(a) to 12(d) are schematic views showing a principle of forming a transparent electrode by using the pattern forming method in accordance with the present invention. As shown in the drawings, the patterning of the transparent electrode is completed by steps (FIGS. 12(a) and 12(b)) of pressing the silicone rubber blanket (width of convex portion: 70 micron, interval between convex portions: 10 micron, number of convex portions: 120 to 160) 22 provided with the micro stripe-shaped convex portion to the photosensitive resin (film thickness: 1 to 2 micron) 32 formed on the silicone sheet (type: S-34, manufactured by TEIJIN CO. LTD.), and taking out only the portion corresponding to the convex portion of the silicone rubber blanket 22 without generating any stringiness phenomenon in the photosensitive resin 32 on the silicone sheet 35, a step (FIG. 12(c)) of transcribing the photosensitive resin coated film 32 formed on the convex portion of the silicone rubber blanket 22 to the transparent electrode layer 59 on the glass substrate 42 corresponding to the subject to be printed without generating any stringiness phenomenon, and a step (FIG. 12(d)) of developing the transparent electrode layer 59 on which the photosensitive resin layer 32 is formed, in accordance with a predetermined condition, and thereafter removing the photosensitive resin 32.

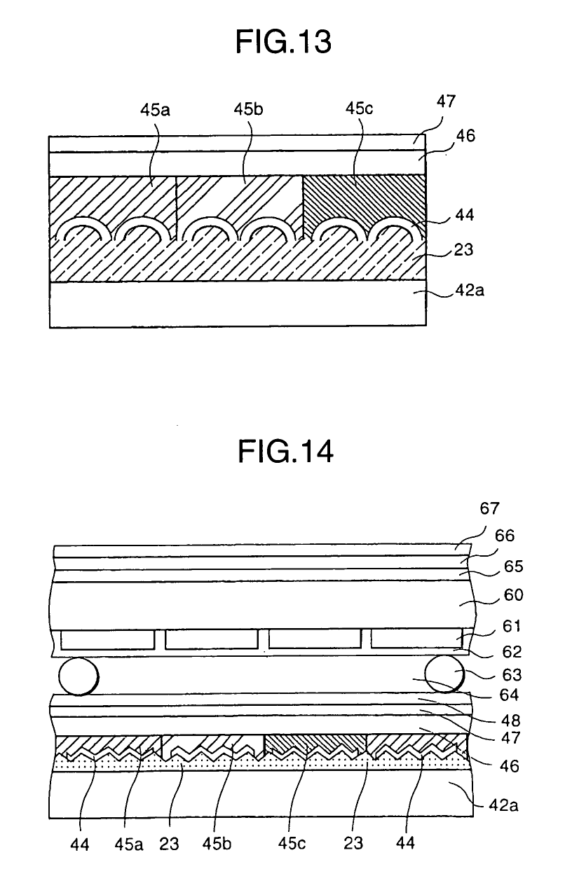

Next, FIG. 13 shows a cross sectional view of an electrode substrate in which a color filter is laminated on the reflecting diffuser formed mainly in accordance with the pattern forming method of the present invention. As shown in the drawing, the electrode substrate is formed by a step of forming the concavity and convexity resin layer 23 by the acrylic group resin, the epoxy group resin or the like colored by the black pigment in accordance with the present pattern forming method, a step of removing only the reflective layer of the portion corresponding to the black matrix portion of the reflective layer 44 formed on the concavity and convexity resin layer 23 in accordance with the photosensitive resin pattern forming method mentioned above, a step of forming the color filter such that adjacent color filters 45a, 45b and 45c are in contact with each other on the black-colored concavity and convexity resin layer 23 from which the reflective layer 44 is removed, a step of forming a leveling layer 46 on the color filters 45a, 45b and 45c by using the principle of the pattern forming method in accordance with the present invention, and a step of patterning the transparent electrode layer on the leveling layer 46 in accordance with the photosensitive resin pattern forming method mentioned above.

Further, in the present embodiment, the electrode structure can intend to achieve the lower cost not only by using the low cost pattern formation in accordance with the present invention, but also by coloring the concavity and convexity resin layer so as to apply the function of the black matrix, thereby omitting the black filter formation.

In this case, in the drawing, the leveling layer is arranged on the color filter, however, it may be appropriately determined in correspondence to the used display mode or the like whether or not the leveling layer is arranged.

FIG. 14 shows a cross sectional structure of a super twisted nematic mode liquid crystal display device (hereinafter, refer to an STN liquid crystal display device using one electrode substrate shown in FIG. 13 and manufactured mainly in accordance with the pattern forming method of the present invention, and another transparent electrode substrate manufactured by using the photosensitive resin pattern forming method shown in FIG. 12.

As shown in the drawing, the STN liquid crystal display device is manufactured by arranging the one electrode substrate on which the concavity and convexity resin layer 23 having the black pigment dispersed on the glass substrate 42, the reflective layer 44 having the portion corresponding to the black matrix portion removed therefrom, the color filters 45a, 45b and 45c placed in such a manner as to be in contact with each other in the portion having the removed reflective layer, the leveling layer 46, a transparent electrode 47 and an orientation control film 48 are formed, and the another substrate in which a transparent electrode 61 and an orientation control film 62 are formed on a glass substrate 60, so as to oppose to each other via a spacer member 63 at a predetermined gap, and arranging two phase difference plates 65 and 66 and a polarizer 67 on the liquid crystal device structured such that a liquid crystal 64 is filled in the gap.

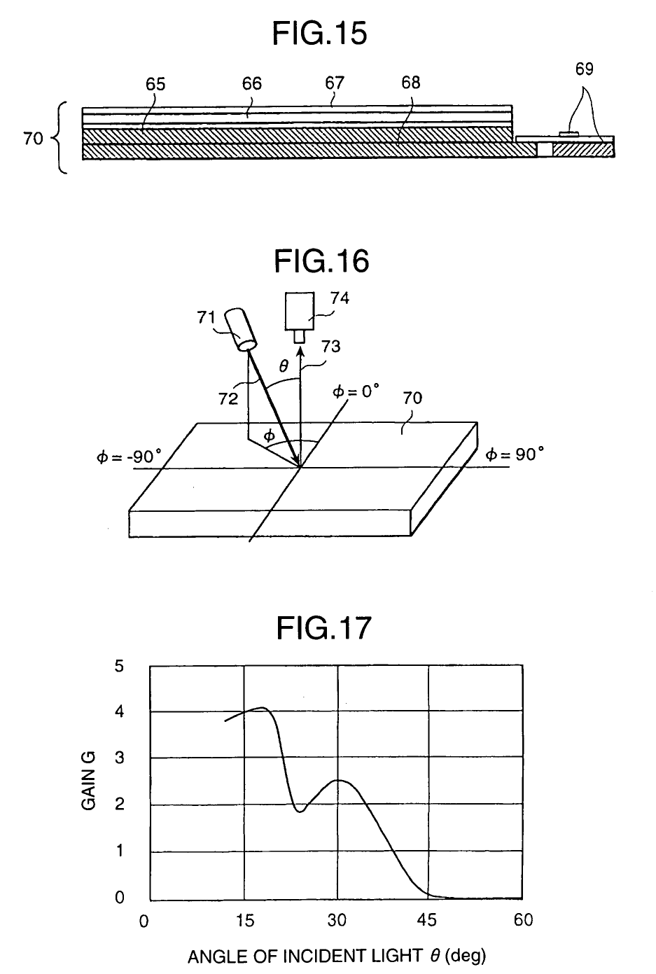

Further, as shown in FIG. 15, an STN liquid crystal display apparatus 70 is manufactured by mounting a liquid crystal drive circuit, a power circuit 69 and the like to the STN liquid crystal display device 68 mentioned above.

Next, FIG. 16 shows an optical system obtained by measuring an optical property of the STN liquid crystal display apparatus manufactured mainly in accordance with the pattern forming method of the present invention. As shown in the drawing, this system is an optical system for measuring an outgoing light 73 emitted in a vertical direction from an STN liquid crystal display apparatus 70 having a reflecting diffuser built-in by a luminance meter 74 with respect to an incident light 72 irradiated from a light source 71, and the measurement can be carried out by variously changing an angle (a direction of Φ and a direction of θ of the light source 71).

FIG. 17 shows an example of the optical property measured by the optical system mentioned above. In the drawing, it can be confirmed that the optical property of the STN liquid crystal display apparatus manufactured mainly in accordance with the pattern forming method of the present invention is a property in which a gain is high in a wide range of angle. In this case, the gain G is defined by a value obtained by dividing a reflection brightness (angle: θ) of the STN liquid crystal display apparatus by a reflection brightness (angle: θ) of a perfect reflecting diffusing plate.

As mentioned above, in accordance with the pattern forming method of the present invention, it is possible to provide the clear STN liquid crystal display apparatus at a low cost.

In this case, the description is given in detail of the present embodiment by exemplifying the STN liquid crystal display apparatus, however, the present invention relates to the method of printing the patterned photosensitive resin onto the subject to be printed and the apparatus thereof, and is not limited to the liquid crystal display apparatus.

(Embodiment 10)

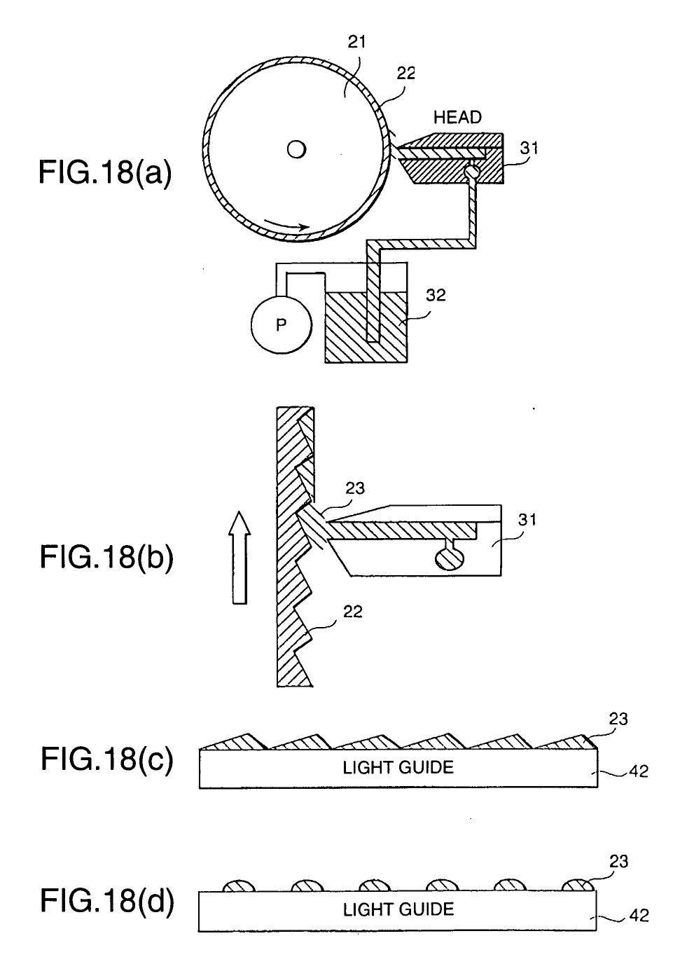

FIG. 18 shows an embodiment of a light guide for a front light which is used in the reflective liquid crystal display apparatus using the pattern forming method in accordance with the present invention. As shown in the drawing, this structure is a method of forming the light guide for the front light utilizing a total reflection condition comprising steps (FIGS. 18(a) and 18(b)) of discharging the resin 32 (OPSTAR manufactured by JSR, refractive index: 1.36 to 1.42) from the die coater head portion 31 of the resin applying unit to the pattern forming unit in which the silicone rubber blanket 22 having a micro gentle slope (width: 100 to 200 micron) and a steep slope (width: 10 to 20 micron) (or a micro circular convex having a predetermined interval) is attached to the cylinder 21, by using the resin applying unit constituted by the die coater, thereby forming the resin coated film 23 having the uniform thickness, and a step (FIG. 18(c) or 18(e)) of transcribing the resin 23 to which the pattern having the gentle and steep slopes on the blanket 22 is transcribed, onto the front surface of the light conducting plate 42 (thickness: 1.8 mm, refractive index: 1.49) corresponding to the subject to be printed made of the acrylic resin forming the subject to be printed.

The resin employed in the present embodiment is the material having approximately the same refractive index as that of the light guide for the front light, belonging to the acrylic group and having the photosensitivity. Further, a transcribing property of the pattern formed on the blanket is further improved by hardening the resin while irradiating the ultraviolet ray from the back surface of the light guide at a time of transcribing the resin pattern-formed on the blanket to the light guide corresponding to the subject to be printed while bringing the resin into contact with the light guide.

Further, in the present embodiment, a gray scale mask (HEBS manufactured by CANION MATERIALS CO., LTD.) and a high sensitive photosensitive resin (type: PC-302 manufactured by JSR) are employed for forming the pattern constituted by the gentle slope (width: 100 to 200 micron) and the steep slope (width: 10 to 20 micron) which are formed on the blanket, thereby accurately manufacturing the shapes of the gentle and steep slopes by the photosensitive resin forming the mother mold and intending to improve a light use efficiency.

As mentioned above, in accordance with the present embodiment, it is possible to obtain an effect that the light guide for the front light having the low cost and the high efficiency can be provided.

Further, by applying the embodiment 7 of the pattern forming method in accordance with the present invention, it is possible to form the micro concavity and convexity pattern (for example, the pattern utilizing the phase separating phenomenon appearing in the copolymer or the like (refer to FIG. 8), material: acrylic resin (OPSTAR manufactured by JSR, refractive index: 1.36 to 1.42), pitch of convexity and concavity: 1.0 to 12.0 micron, step of convexity and concavity: 0.1 to 0.6 micron) which can not be viewed by the observer, on the front surface of the polarizer or the like. Accordingly, since not only it is possible to prevent an image quality from being lowered due to the light regular reflected on the polarizer, but also it is possible to lower the reflected light from the front surface of the light guide by applying a glare treatment and a function of an antireflection film to the polarizer, it is possible to provide the reflective liquid crystal display apparatus by which a high contrast image can be obtained.

The pattern forming method in accordance with the present invention is not limited to the present embodiment, and the printability is not required with respect to the used resin or ink. Accordingly, it is possible to easily apply the pattern formation on the high polymer sheet which has been considered to be hard. Therefore, it is preferable to apply to preparing a prism sheet and a diffused sheet, and it is possible to obtain an effect of achieving a cost reduction and a high performance.

(Embodiment 11)

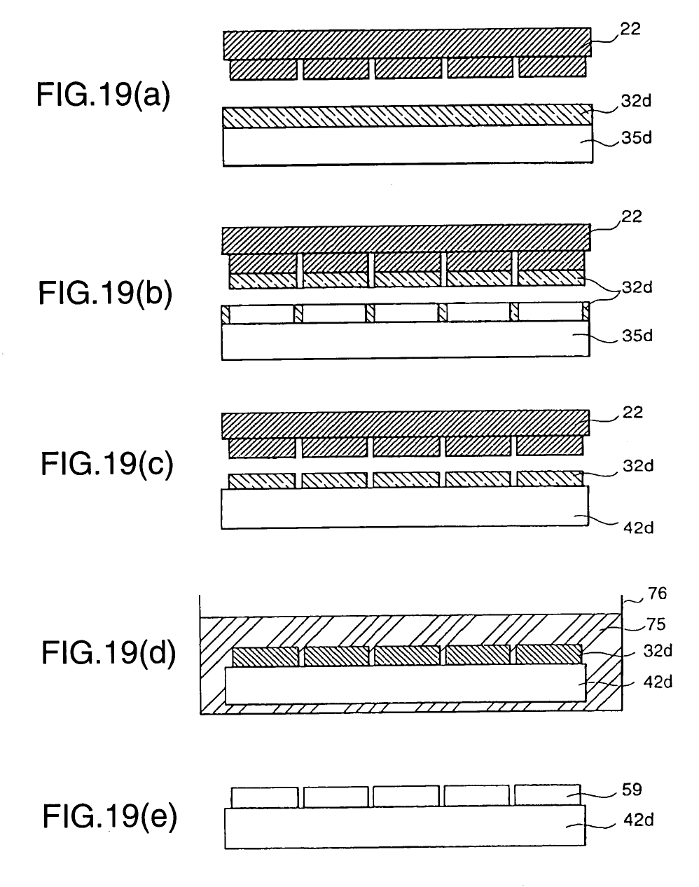

FIG. 19 shows an embodiment of a printed circuit board forming method using the pattern forming method in accordance with the present invention. As shown in the drawing, this structure is a method of forming the completed printed circuit board comprising steps (FIGS. 19(a) and 19(b)) of bringing a convex portion of the wiring pattern relief printing blanket 22 (pattern width: 70 micron, pattern gap: 10 micron, height: 40 micron) made of the silicone rubber into contact with a catalyst coated surface made of a palladium and formed on the silicone sheet 35, thereafter taking out the catalyst in the portion corresponding to the convex portion at a time of detaching the wiring relief printing blanket 22 from the catalyst coated surface without generating the stringiness phenomenon, and patterning the catalyst made of the palladium, a step (FIG. 19(c)) of transcribing the catalyst pattern 32d on the blanket 22 to the printed circuit board 42d made of a glass epoxy resin corresponding to the subject to be printed without generating the stringiness phenomenon, and steps (FIGS. 19(d) and 19(e)) of dipping the printed circuit board 42d to which the catalyst pattern 32d is transcribed into an electroless copper plating solution 75 including a reducing agent, a chelating agent and the like so as to form a copper coating sheet 59 only on the portion where the catalyst pattern 32d is printed.

In this case, the palladium is employed as the catalyst used in the present embodiment, however, a surface treatment is applied for making the copper ion to be adsorbed only to the catalyst pattern portion accurately.

The printed circuit board has been conventionally manufactured in accordance with an electroless copper plating process having a lot of complex steps using a photo lithography method, however, in accordance with the pattern forming method of the present invention, since the printing process is simple and has a reduced number of steps, it is possible to obtain an effect that the printed circuit board can be provided at a low cost.

Further, in the present embodiment, since the pattern can be formed on the catalyst without using the liquid photosensitive resin obtained by dissolving the photosensitive resin by a solvent, it is possible to provide an environment-friendly pattern forming method.

In this case, as an application using the plating technique in accordance with the present embodiment, there can be listed up a wiring pattern formation of gold, nickel and the like in addition to the copper applied onto the polymer film, the glass substrate and the silicone substrate.

The pattern forming method in accordance with the present invention is variously applied to next-generation technologies such as formation of an organic electroluminescence light emitting layer, an organic thin film transistor semiconductor resin pattern and the like, to say nothing of alternative technologies of the structures formed by the printing and transcribing method in addition to the patterning technology in accordance with the currently mainstream photo lithography method. Accordingly, the pattern forming method in accordance with the present invention is not limited to the embodiment mentioned above.

Further, the present invention can be applied to formation of a structure requiring a cross sectional shape control, such as a micro lens or the like which has been conventionally considered to be hard.

In connection with the liquid crystal display apparatus, the present invention can be applied to a transparent electrode, a patterning resist printing of a printed circuit board (including a flexible print circuit (hereinafter, refer to as FPC), a color filter (including a black matrix), an over coat (a leveling layer, an insulating layer and the like), a reflecting diffuser, a micro lens array, a reflecting diffuser and the like.

1. A pattern forming method comprising the steps of:
forming a resin on one face on a member in which a printing pattern is formed on a surface and at least the surface having the printing pattern formed thereon is siliconized; and
transcribing the resin formed on said member on a subject to be printed.

2. A pattern forming method as claimed in claim 1, wherein said siliconization is achieved by arranging a silicone rubber, a silicone resin or a silicone sheet on the surface of the member.

3. A pattern forming method as claimed in claim 1, wherein the resin is formed on said member in such a manner that a thickness of the resin is approximately uniform.

4. A pattern forming apparatus comprising:
a member in which a pattern is formed on a surface and at least the surface having the pattern formed thereon is siliconized;
a resin supplying means for supplying a resin to one face of the surface having the pattern formed thereon in said member; and
a supporting means for supporting a subject to be printed so as to transcribe the resin supplied to said member on the subject to be printed.

5. A pattern forming apparatus as claimed in claim 4, wherein said siliconization is achieved by arranging a silicone rubber, a silicone resin or a silicone sheet on the surface of said member.

6. A pattern forming apparatus as claimed in claim 4, wherein said member is formed in a cylindrical shape.

7. A pattern forming apparatus as claimed in claim 4, wherein said member is formed in a flat plate shape

8. A pattern forming apparatus as claimed in claim 4, wherein said resin supplying means supplies the resin to one face of the surface of said member in such a manner that the thickness becomes approximately uniform.

9. A pattern forming apparatus as claimed in claim 4, wherein said resin supplying means supplies the resin to said member from a resin supplying port, and a siliconization is applied to said resin supplying port.

10. A pattern forming apparatus as claimed in claim 4, wherein said resin supplying means is constituted by a die coater, a wire bar coater, a blade coater or a kiss coater.

11. A pattern forming apparatus comprising:
a member having a printing plate function and a ink separating function;
a means for forming and supplying a resin thin film to said member; and
a supporting means for supporting a subject to be printed.

12. A pattern forming apparatus as claimed in claim 11, wherein said member is provided with a silicone, a silicone rubber, a silicone resin or a silicone sheet on a surface thereof.

13. A pattern forming apparatus as claimed in claim 12, wherein said silicone rubber, said silicone resin or said silicone sheet attached to the surface of said member has a printing pattern.
